(19) United States
(12) Patent Application Publication
(10) Pub. No.: US 2018/0264740 A1
(43) Pub. Date: Sep. 20, 2018

(54) MANUFACTURING APPARATUS AND MANUFACTURING METHOD FOR THREE-DIMENSIONAL OBJECT AND THREE-DIMENSIONAL OBJECT

(71) Applicant: MIMAKI ENGINEERING CO., LTD., Nagano (JP)

(72) Inventor: Masaru OHNISHI, Nagano (JP)

(73) Assignee: MIMAKI ENGINEERING CO., LTD., Nagano (JP)

(21) Appl. No.: 15/917,851

(22) Filed: Mar. 12, 2018

(30) Foreign Application Priority Data
Mar. 16, 2017 (JP) 2017-051970
Sep. 19, 2017 (JP) 2017-179539

(51) Int. Cl. B29C 64/393; B33Y 30/00; B33Y 80/00; B33Y 10/00; B33Y 70/00; B33Y 50/02; B29C 64/112; B29C 64/291

(52) U.S. Cl. CPC B29C 64/393; B33Y 30/00; B33Y 80/00; B33Y 10/00; B29K 2105/0032; B33Y 50/02; B29C 64/112; B29C 64/291; B33Y 70/00

(57) ABSTRACT

A three-dimensional object manufacturing apparatus has an input receiver, a three-dimensional shaping information generator, and a shaping part. The input receiver has a yarn-related information receiver that receives information inputted of a yarn, and a weaving method receiver that receives information inputted of a weaving method for the yarn. The three-dimensional shaping information generator generates three-dimensional shaping information of the three-dimensional object based on the yarn-related information and the information of the yarn weaving method. The shaping part forms the three-dimensional object on a working plane by ejecting an object forming material onto the working plane and curing the ejected material based on the three-dimensional shaping information.

### CROSS REFERENCE TO RELATED APPLICATIONS

This application claims the priority benefit of Japanese Patent Application No. 2017-179539, filed on Sep. 19, 2017 and Japanese Patent Application No. 2017-051970, filed on Mar. 16, 2017. The entirety of the above-mentioned patent application is hereby incorporated by reference herein and made a part of this specification.

### TECHNICAL FIELD

This disclosure relates to a manufacturing apparatus and a manufacturing method for three-dimensional object, and a three-dimensional object.

### DESCRIPTION OF THE BACKGROUND ART

Among the known manufacturing methods for interior materials that appear to have weave structures of real textile fabrics, inkjet printers may be used to directly print interior patterns on film-like or plate-like target media. Specific examples of such inkjet printing may include direct printing of interior patterns on textile fabrics, and direct printing of patterns of textile weave structures on plastic media.

Some known three-dimensional shaping apparatuses may form a three-dimensional object by stacking a sheet-like object forming material in layers on a working plane in a predetermined layer-stacking direction. These three-dimensional shaping apparatuses may use, as functional ink, ultraviolet-curable ink curable by being irradiated with ultraviolet light. The object forming material is obtained by curing the ultraviolet-curable ink. Some of the three-dimensional objects formed by such an apparatus may be decorated with colors. Known examples of the colored three-dimensional objects may include three-dimensional architectural models provided with coating, as described in, for example, Japanese Patent Application Laid-Open No. 2004-155007.

### SUMMARY

The manufacture of interior materials by directly printing interior patterns on textile fabrics may conventionally require the use of aqueous pigment ink for textile printing or ultraviolet-curable ink. The aqueous pigment ink for textile printing may easily bleed out and spread. To prevent this unfavorable event, a textile fabric should be provided in advance with an image layer coating suitable for the ink used before the printing starts. This may involve the risk of cost increase in the manufacture of an interior material. Another risk may be absorption of soiled water into the image layer. The interior material may be thereby easily soiled, and any dirt and/or stain, if adhered, may be difficult to wash off. In a case where the ultraviolet-curable ink is used, ink layers formed on the textile fabric may be thick and hard, possibly failing to reproduce the appearance and texture of a real textile fabric.

The manufacture of interior materials by directly printing patterns of textile weave structures on plastic media conventionally requires the use of ultraviolet-curable ink. Such a printing method may allow patterns of textile weave structures to be expressed well with raised ink dots and may provide a product hardly soiled. On the other hand, fine meshes in a real textile structure may be difficult to reproduce, and the appearance and texture of a real textile fabric may be accordingly difficult to reproduce.

A remaining issue to be addressed may be a time-consuming designing work when a three-dimensional network structure is designed and manufactured.

To address these issues of the known art, this present disclosure provides a manufacturing apparatus and a manufacturing method for a three-dimensional object with the appearance and texture of a real textile fabric that may be hardly soiled, and such a three-dimensional object.

A manufacturing apparatus for a three-dimensional object includes: a yarn-related information receiver that receives information inputted of a yarn; a weaving method receiver that receives information inputted of a weaving method for the yarn; a three-dimensional shaping information generator that generates three-dimensional shaping information of the three-dimensional object based on the information of the yarn and the information of the weaving method for the yarn; and a shaping part that shapes the three-dimensional object on a working plane by ejecting an object forming material onto the working plane and curing the object forming material ejected based on the three-dimensional shaping information.

In the manufacturing apparatus thus characterized, the three-dimensional shaping information may include information of a shape in cross section of a structure of the yarn, the shape in cross section of the structure of the yarn may be rounded, and the shaping part may shape the three-dimensional object so that the shape in cross section of the structure of the yarn is rounded.

In the manufacturing apparatus thus further characterized, the three-dimensional shaping information may include information of an overlap between the structures of a plurality of the yarns, the shaping part may start with shaping the structure of one of the plurality of the yarns on a side closer to the working plane than the structure of a main yarn among the plurality of the yarns, then proceed to shaping the structure of the main yarn during a scan performed along a direction in which the structure of the main yarn extends, and finally shape the structure of one of the plurality of the yarns on a side opposite to the working plane relative to the structure of the main yarn.

In the manufacturing apparatus thus further characterized, the three-dimensional shaping information generator may generate a piece of three-dimensional shaping information per minimum unit based on the information of the yarn and the information of the weaving method and repeatedly process the piece of three-dimensional shaping information per minimum unit to generate the three-dimensional shaping information of the three-dimensional object.

In the manufacturing apparatus thus further characterized, the three-dimensional shaping information generator may set an opaque ink-usable region in the three-dimensional shaping information of the three-dimensional object, and the shaping part may shape the three-dimensional object based on the three-dimensional shaping information of the three-dimensional object in which the opaque ink-usable region is set. In the manufacturing apparatus thus further characterized, the three-dimensional shaping information generator may set the use of an opaque ink in the three-dimensional shaping information of the three-dimensional object, and the shaping part may shape the three-dimensional object using the opaque ink. In the manufacturing apparatus thus further characterized, the opaque ink may include a white pigment, and the white pigment may include any one selected from a hollow white pigment, micro-encapsulated titanium oxide, micro-encapsulated zinc oxide, and nanoparticles having an average particle size less than or equal to 300 nm.

In the manufacturing apparatus thus further characterized, the three-dimensional shaping information generator may include information of a pattern in the three-dimensional shaping information, and the shaping part may shape the three-dimensional object and then print the pattern thereon.

In a case where the shaping part is configured to print the pattern, the pattern may be at least one selected from information of decoration of the yarn, information of a raw material of the yarn and a twining state of the yarn, and information of decoration of a textile fabric formed by weaving the yarn.

In the manufacturing apparatus thus further characterized, the yarn-related information receiver and the weaving method receiver may respectively receive information of a plurality of combinations of the yarns and information of a weaving method for the plurality of combinations of the yarns, the three-dimensional shaping information generator may generate a plurality of pieces of three-dimensional shaping information of the three-dimensional object based on the information of the plurality of combinations of the yarns and information of the weaving method for the plurality of combinations of the yarns and combine the plurality of pieces of three-dimensional shaping information to generate three-dimensional shaping information of a composite three-dimensional object, and the shaping part may shape the composite three-dimensional object based on the three-dimensional shaping information of the composite three-dimensional object.

In the manufacturing apparatus thus further characterized, the three-dimensional shaping information generator may include information of an image in the three-dimensional shaping information, and a printing part is further provided that prints an image on a surface of the three-dimensional object or the composite three-dimensional object based on the three-dimensional shaping information including the information of an image.

A manufacturing method for a three-dimensional object includes: a yarn-related information receiving step of receiving information inputted of a yarn; a weaving method receiving step of receiving information inputted of a weaving method for the yarn; a three-dimensional shaping information generating step of generating three-dimensional shaping information of the three-dimensional object based on the information of the yarn and the information of the weaving method for the yarn; and an object shaping step of shaping the three-dimensional object on a working plane by ejecting an object forming material onto the working plane and curing the object forming material ejected based on the three-dimensional shaping information.

Another manufacturing apparatus for a three-dimensional object is further provided. The manufacturing apparatus manufactures a textile-like structural object that appears to be a textile fabric formed by interweaving a plurality of warp yarns and a plurality of weft yarns. The manufacturing apparatus includes a shaping part that shapes the three-dimensional object on a working plane by ejecting an object forming material onto the working plane and curing the object forming material ejected. The shaping part forms a part with an overlap between structures of respective ones of the plurality of warp yarns and the plurality of weft yarns in a greater thickness in a view from a surface side than a part with no overlap between the structures of the plurality of warp yarns and the plurality of weft yarns.

In the manufacturing apparatus thus characterized, the shaping part may start with shaping the structure of a lower-side yarn in the part with the overlap and then shape the structure of an upper-side yarn in the part with the overlap.

In the manufacturing apparatus in which the shaping part is configured to start with shaping the structure of the lower-side yarn in the part with the overlap and then shape the structure of the upper-side yarn in the part with an overlap, the shaping part may shape the structure of the upper-side yarn in the part with the overlap in a greater thickness than the structure of the upper-side yarn in any part but the part with the overlap, or the shaping part may shape the structure of the upper-side yarn in the part with the overlap in a thickness of the structures stacked in layers of the upper-side yarn and the lower-side yarn in the part with the overlap, instead of further shaping the structure of the lower-side yarn in the part with the overlap.

In the manufacturing apparatus in which the shaping part is configured to start with shaping the structure of the lower-side yarn in the part with the overlap and then shape the structure of the upper-side yarn in the part with the overlap, the shaping part may shape the structure of the upper-side yarn in the part with the overlap so as to have a taper starting from the part with the overlap toward a part with no overlap between the structures of respective ones of the plurality of warp yarns and the plurality of weft yarns.

In the manufacturing apparatus thus further characterized, the shaping part may use an opaque ink to shape the three-dimensional object. The opaque ink may include a white pigment, and the white pigment may include any one selected from a hollow white pigment, micro-encapsulated titanium oxide, micro-encapsulated zinc oxide, and nanoparticles having an average particle size less than or equal to 300 nm.

A three-dimensional object is provided that includes a plurality of structures of first yarn formed by ejecting and curing an object forming material and extending in a direction, and a plurality of structures of second yarn formed by ejecting and curing an object forming material and extending in another direction intersecting with the plurality of structures of first yarn. The plurality of structures of first yarn and the plurality of structures of the second yarns are interwoven in the three-dimensional object.

In the three-dimensional object thus characterized, at least one of respective ones of the plurality of structures of first yarn and the plurality of structures of second yarn may include an opaque ink. The opaque ink may include a white pigment, and the white pigment may include any one selected from a hollow white pigment, micro-encapsulated titanium oxide, micro-encapsulated zinc oxide, and nanoparticles having an average particle size less than or equal to 300 nm.

As thus far described, this disclosure provides a manufacturing apparatus and a manufacturing method for a three-dimensional object with the appearance and texture of a real textile fabric that may be hardly soiled, and such a three-dimensional object.

### BRIEF DESCRIPTION OF THE DRAWINGS

FIG. 1 is a block diagram that schematically illustrates structural features of a three-dimensional object manufacturing apparatus according to a first embodiment.

FIG. 2 is a plan view of three-dimensional shaping information of the three-dimensional object processed by the three-dimensional object manufacturing apparatus according to the first embodiment.

FIG. 3 is an A-A cross-sectional view of the three-dimensional shaping information of the three-dimensional object illustrated in FIG. 2.

FIG. 4 is a drawing that illustrates a part of information processing when the three-dimensional shaping information of the three-dimensional object illustrated in FIG. 2 is processed.

FIG. 5 is a drawing that illustrates another part of information processing when the three-dimensional shaping information of the three-dimensional object illustrated in FIG. 2 is processed.

FIG. 6 is a flowchart of a manufacturing method for the three-dimensional object according to the first embodiment.

FIG. 7 is a cross-sectional view of an exemplified distribution of coloring inks included in an object forming material in three-dimensional shaping information of a three-dimensional object according to a second embodiment.

FIG. 8 is a cross-sectional view of another exemplified distribution of the coloring inks included in the object forming material in the three-dimensional shaping information of the three-dimensional object according to the second embodiment.

FIG. 9 is a cross-sectional view of still another exemplified distribution of the coloring inks included in the object forming material in the three-dimensional shaping information of the three-dimensional object according to the second embodiment.

FIG. 10 is a cross-sectional view of still another exemplified distribution of the coloring inks included in the object forming material in the three-dimensional shaping information of the three-dimensional object according to the second embodiment.

FIG. 11 is a cross-sectional view of still another exemplified distribution of the coloring inks included in the object forming material in the three-dimensional shaping information of the three-dimensional object according to the second embodiment.

FIG. 12 is a cross-sectional view of still another exemplified distribution of the coloring inks included in the object forming material in the three-dimensional shaping information of the three-dimensional object according to the second embodiment.

FIG. 13 is a cross-sectional view of still another exemplified distribution of the coloring inks included in the object forming material in the three-dimensional shaping information of the three-dimensional object according to the second embodiment.

FIG. 14 is a plan view of an exemplified three-dimensional object according to the first embodiment.

FIG. 15 is a plan view of an exemplified three-dimensional object according to the second embodiment.

FIG. 16 is a cross-sectional view of an exemplified three-dimensional object according to a third embodiment.

FIG. 17 is a plan view of three-dimensional shaping information of a three-dimensional object processed by a three-dimensional object manufacturing apparatus according to a fourth embodiment.

FIG. 18 is a schematic drawing of information of a yarn structure processed by the three-dimensional object manufacturing apparatus according to the fourth embodiment.

FIG. 19 is another schematic drawing of information of a yarn structure processed by the three-dimensional object manufacturing apparatus according to the fourth embodiment.

FIG. 20 is a drawing including a plan view and a cross-sectional view of three-dimensional shaping information of a three-dimensional object processed by a three-dimensional object manufacturing apparatus according to a fifth embodiment.

FIG. 21 is a plan view of three-dimensional shaping information of a three-dimensional object processed by a three-dimensional object manufacturing apparatus according to a sixth embodiment.

FIG. 22 is a plan view of three-dimensional shaping information of a three-dimensional object processed by a three-dimensional object manufacturing apparatus according to a seventh embodiment.

FIG. 23 is a plan view of three-dimensional shaping information of a composite three-dimensional object processed by a three-dimensional object manufacturing apparatus according to an eighth embodiment.

### DETAILED DESCRIPTION OF EMBODIMENTS

Non-limiting embodiments of this disclosure are hereinafter described in detail referring to the accompanying drawings. The present disclosure is not limited by the embodiments described below, and structural means described in the embodiments may include means that are easily replaceable or made available by those skilled in the art or substantially identical means. The structural means described in the embodiments may be optionally combined, and respective ones of the embodiments may also be optionally combined.

### First Embodiment

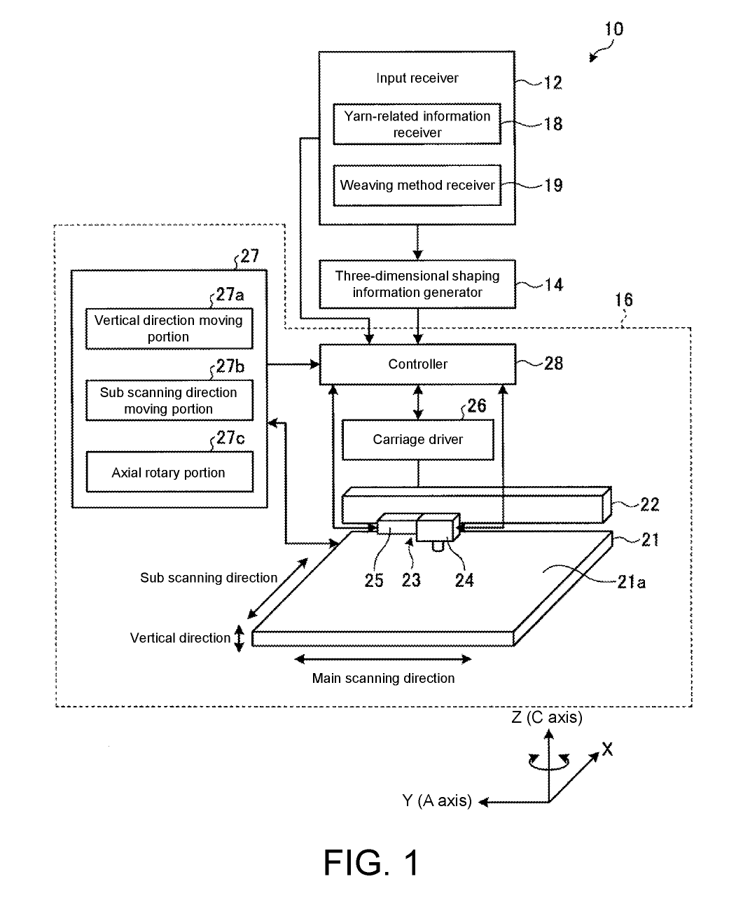

FIG. 1 is a block diagram that schematically illustrates structural features of a three-dimensional object manufacturing apparatus 10 according to a first embodiment. The three-dimensional object manufacturing apparatus 10 manufactures a three-dimensional object structured and appearing like a textile fabric formed by interweaving a plurality of warp yarns and a plurality of weft yarns. As illustrated in FIG. 1, the three-dimensional object manufacturing apparatus 10 includes an input receiver 12, a three-dimensional shaping information generator 14, and a shaping part 16.

Information from outside is inputted to and received by the input receiver 12. A specific example of the input receiver 12 may be a user interface including a keyboard, a mouse, and a touch panel also serving as a display device. As illustrated in FIG. 1, the input receiver 12 includes a yarn-related information receiver 18 and a weaving method receiver 19. The yarn-related information receiver 18 receives information inputted of a yarn(s) used to form textile-like structures of the three-dimensional object. The input receiver 12 receives information inputted of a depth in cross section of the three-dimensional object to be formed and information inputted of condition settings for object shaping. The input receiver 12 transmits the received information of a depth in cross section of the three-dimensional object and information of condition settings for object shaping to a controller 28 of the shaping part 16.

The yarn-related information receiver 18 receives information inputted of an optional number of yarns including one or more yarns. The weaving method receiver 19 receives information inputted of a weaving method for the yarn(s). The input receiver 12 may have the yarn-related information receiver 18 receive the inputted information of a yarn(s) and then have the weaving method receiver 19 receive information of a weaving method for the yarn(s) inputted to and received by the yarn-related information receiver 18. Alternatively, the input receiver 12 may have the weaving method receiver 19 receive inputted information of a yarn weaving method and then have the yarn-related information receiver 18 receive information of a yarn(s) woven by the yarn weaving method inputted to and received by the weaving method receiver 19. The yarn-related information may include the number of different types of yarns to be woven (number of yarns), raw material(s) of a yarn(s), thickness(es) of a yarn(s), degree(s) of hardness of a yarn(s), shape(s) in cross section of a yarn(s), twining state(s) of a yarn(s), and color(s) of a yarn(s).

The input receiver 12 is coupled to the three-dimensional shaping information generator 14 to allow these devices to transmit and receive information to and from each other. The input receiver 12 transmits the received information; yarn-related information inputted to and received by the yarn-related information receiver 18, and yarn weaving method inputted to and received by the weaving method receiver 19, to the three-dimensional shaping information generator 14.

The three-dimensional shaping information generator 14 receives from the input receiver 12 the information inputted to and received by the input receiver 12, for example, information of a yarn(s) inputted to and received by the yarn-related information receiver 18 and information of a weaving method for the yarn(s) inputted to and received by the weaving method receiver 19. The three-dimensional shaping information generator 14 generates the three-dimensional shaping information of the three-dimensional object to be formed by the shaping part 16 based on the yarn-related information inputted to and received by the yarn-related information receiver 18 and the yarn weaving method inputted to and received by the weaving method receiver 19. The three-dimensional shaping information generator 14 may include information of a depth in cross section of a three-dimensional object to be formed in the three-dimensional shaping information of the three-dimensional object. The three-dimensional shaping information generator 14 transmits the generated three-dimensional shaping information to the controller 28 of the shaping part 16.

The three-dimensional shaping information generator 14 may generate a piece of three-dimensional shaping information per minimum unit based on the yarn-related information and the weaving method information and repeatedly process the piece of three-dimensional shaping information per minimum unit to generate three-dimensional shaping information of a three-dimensional object structured and sized as predefined.

The three-dimensional shaping information generator 14 includes a storage device and a processor. The storage device includes storage means, for example, RAM, ROM, and flash memory. In the storage are stored software programs to be processed by the processor and data used for reference by the software programs.

In the storage device are stored, specifically, programs run to prompt the processor to generate the three-dimensional shaping information of the three-dimensional object. The storage device further serves as a storage region in which processing results of the processor are temporarily stored. The processor reads the software programs from the storage device and processes the read programs to effectuate functions that depend on contents of the software programs. To be specific, the processor reads the programs from the storage device and processes the read programs to function as the three-dimensional shaping information generator 14 and generate the three-dimensional shaping information of the three-dimensional object. The three-dimensional shaping information generator 14 may store the generated three-dimensional shaping information of the three-dimensional object in the storage device, and may display the three-dimensional shaping information of the three-dimensional object on a display device provided in the three-dimensional shaping information generator 14. A typical example of the three-dimensional shaping information generator 14 may be a computer.

In the input receiver 12, any correction(s) of the yarn-related information may be inputted to and received by the yarn-related information receiver 18, and/or any correction(s) of the information of the yarn weaving method may be inputted to and received by the weaving method receiver 19, with the three-dimensional shaping information of the three-dimensional object being checked on the display device of the three-dimensional shaping information generator 14. When any correction(s) of the yarn-related information and the information of the yarn weaving method is received by the input receiver 12, the three-dimensional shaping information generator 14 accordingly corrects the three-dimensional shaping information of the three-dimensional object.

The shaping part 16 forms a three-dimensional object on a working plane 21a by ejecting an object forming material onto the working plane 21a and curing the ejected material based on the three-dimensional shaping information generated by the three-dimensional shaping information generator 14. A typical example of the shaping part 16 may be an inkjet 3D printer. As illustrated in FIG. 1, the shaping part 16 includes a table 21, a Y bar 22, a carriage 23, inkjet heads 24, an ultraviolet irradiator 25, a carriage driver 26; as a head driver, a table driver 27, and a controller 28.

The table 21 is a plate-like member extending along a horizontal plane which is an X-Y plane illustrated in FIG. 1. The upper surface of the table 21 in the vertical direction, which is Z direction illustrated in FIG. 1, is the working plane 21a. The working plane 21a has a flat shape parallel to the horizontal plane. A medium is set on the working plane 21a. The working plane 21a of the table 21 has a rectangular shape, which is a non-limiting example.

Examples of the medium to be set on the working plane 21a may include plastic films, plastic plates, metal plates, glass plates, synthetic plates, wooden and synthetic building materials, unwoven fabrics, and plastic membranes. The object forming material is ejected onto and cured on the upper surface of the medium set on the working plane 21a, so that a plurality of unit layers, each being a layer of the cured object forming material, are stacked on one another from the vertically lower side toward the vertically upper side. As a result, a three-dimensional object is formed on the working plane 21a. The medium used in this embodiment is a film-like or plate-like medium, which is a non-limiting example. Other possible examples of the medium may include columnar media and various types of 3D objects.

The Y bar 22 is spaced away from the table 21 by a predetermined distance in the Z direction of FIG. 1, i.e., on the vertically upper side of the table 21. The Y bar 22 is a linear member extending in the horizontal direction illustrated in FIG. 1, specifically, a main scanning direction parallel to Y axis. The Y bar 22 guides the carriage 23 to move in reciprocating motion along the main scanning direction.

The carriage 23 is supported and held by the Y bar 22 and is movable in reciprocating motion along the Y bar 22 in Y direction, i.e., main scanning direction. The carriage 23 is controlled to move in the main scanning direction. The carriage 23 is mounted with and holds the inkjet heads 24 and the ultraviolet irradiator 25 on a surface vertically facing the working plane 21a of the table 21.

The inkjet head 24 ejects ultraviolet-curable ink as the object forming material onto the working plane 21a. The inkjet heads 24 are mounted in the carriage 23 and are movable in reciprocating motion in the main scanning direction correspondingly to the movement of the carriage 23 in the main scanning direction. The inkjet heads 24 are coupled to ink tanks, not illustrated in the drawing, mounted in the carriage 23 through, for example, ink flow paths, a regulator, and a pump. One or more inkjet heads 24 may be provided in accordance with the number of types of ultraviolet-curable inks used to form a three-dimensional object. The inkjet heads 24 ejects the ultraviolet-curable inks from the ink tanks onto the working plane 21a of the table 21. The inkjet heads 24 are electrically coupled to the controller 28 and are controlled to operate by the controller 28.

The ultraviolet-curable inks to be ejected from the inkjet heads 24 may be decided based on the yarn-related information inputted to and received by the yarn-related information receiver 18, for example, information on types of yarns, information on degrees of hardness of yarns, and information on colors of yarns. The ultraviolet-curable ink ejected from the inkjet head 24, after being cured, may have a degree of rubber hardness pursuant to JIS 6253 less than or equal to 90 or preferably less than or equal to 80. A three-dimensional object using such ultraviolet-curable inks may provide a good soft touch and texture as if it was a real textile fabric after the inks are cured, and thus a three-dimensional object to be shaped has more realistic texture.

An example of such an ultraviolet-curable ink may be an ink containing an oligomer, an urethane resin, and an ultraviolet absorbent; ultraviolet curing initiator, and optionally further containing a transparent ink or a colorant such as a coloring ink. Examples of the oligomer may include urethane acrylate-based oligomers, and acrylate-based and acrylic urethane resin-based oligomers having low glass transition points. Examples of the urethane resins may include low-viscosity acrylic monomers, isocyanates, and diols. Examples of the ultraviolet absorbent; ultraviolet curing initiator, may include radical ultraviolet curing initiators, for example, acetophenone-based ultraviolet absorbents, α-aminoacetophenone-based ultraviolet absorbents, acylphosphineoxide radical-based ultraviolet absorbents, O-acyloxime-based ultraviolet absorbents, titanocene ultraviolet curing initiators, bimolecular-reactive ultraviolet curing initiators, and may further include cationic ultraviolet curing initiators. The ultraviolet absorbent desirably used may have very low absorbability for a visible light region that does not undermine color developed by the colorant and may have absorbability as large as possible for an ultraviolet region. The ultraviolet absorbent desirably used may be thermally stable and unlikely to burn or develop color under heat at the time of instantaneous heating.

Examples of coloring inks used in the ultraviolet-curable inks may include white, cyan (C), magenta (M), yellow (Y), and black (K) inks. Examples of the transparent ink may include special coloring materials such as clear ink. Instead of the non-limiting examples of the coloring ink mentioned earlier, red (R), green (G), and blue (B) inks, and special color inks including pearl and metallic inks may also be used. The coloring inks having any colors may be optionally used insofar as at least one or more colors are obtainable. The ultraviolet-curable ink may further contain an adjuster, such as a solvent, to adjust the viscosity and surface tension.

The ultraviolet irradiator 25 irradiates the ultraviolet-curable ink ejected onto the working plane 21a with ultraviolet light. The ultraviolet irradiator 25 may include an ultraviolet-emitting LED module. The ultraviolet-emitting LED module constituting the ultraviolet irradiator 25 may emit ultraviolet light having a wavelength between 250 nm and 400 nm, a range of radiation from semiconductor LED, and more preferably a wavelength between 360 nm and 400 nm. The ultraviolet irradiator 25 is mounted in the carriage 23 and is movable in reciprocating motion in the main scanning direction correspondingly to the movement of the carriage 23 in the main scanning direction. The ultraviolet irradiator 25 is electrically coupled to the controller 28 and is controlled to operate by the controller 28.

The carriage driver 26 drives the carriage 23, i.e., the inkjet heads 24 and the ultraviolet irradiator 25, to move in reciprocating motion (scan) relative to the Y bar 22 in the main scanning direction. The carriage driver 26 may include a transmission mechanism coupled to the carriage 23 such as a transport belt, and a drive source that drives the transport belt such as an electric motor. The carriage driver 26 converts, through the transmission mechanism, motive power generated by the drive source into motive power that moves the carriage 23 in the main scanning direction. Thus, the carriage 23 is prompted to move in reciprocating motion in the main scanning direction. The carriage driver 26 is electrically coupled to the controller 28 and is controlled to operate by the controller 28.

The table driver 27 moves the table 21 relative to the inkjet heads 24. As illustrated in FIG. 1, the table driver 27 includes a vertical direction moving portion 27a, a sub scanning direction moving portion 27b, and an axial rotary portion 27c which is a C-axis rotation driver.

The vertical direction moving portion 27a vertically (Z direction) moves the table 21 upward and downward to vertically move the working plane 21a of the table 21 upward and downward relative to the inkjet heads 24. The table driver 27 is thus allowed to vertically move the working plane 21a toward and away from the inkjet heads 24 and the ultraviolet irradiator 25, i.e., the table driver 27 allows relative movement of the working plane 21a to the inkjet heads 24 and the ultraviolet irradiator 25.

The sub scanning direction moving portion 27b moves the table 21 in a sub scanning direction parallel to the X direction orthogonal to the main scanning direction and thereby moves the working plane 21a of the table 21 in reciprocating motion in the sub scanning direction relative to the inkjet heads 24. The table driver 27 is thus allowed to move the working plane 21a in reciprocating motion in the sub scanning direction relative to the inkjet heads 24 and the ultraviolet irradiator 25. That is, the sub scanning direction moving portion 27b allows relative movements of the inkjet heads 24, ultraviolet irradiator 25, and working plane 21a in reciprocating motion in the sub scanning direction. In this embodiment, the sub scanning direction moving portion 27b moves the table 21 in the sub scanning direction. However, this is a non-limiting example of this disclosure. The sub scanning direction moving portion 27b may move the inkjet heads 24 and the ultraviolet irradiator 25, together with the Y bar 22, in the sub scanning direction.

The axial rotary portion 27c rotates the table 21 around the C axis and thereby rotates the working plane 21a of the table 21 relative to the inkjet heads 24. The axial rotary portion 27c functions as a generally called revolving table. The C axis is extending in a direction perpendicular to the flat working plane 21a of the table 21 and parallel to the vertical direction. The table driving portion 27 is thus allowed to rotate the working plane 21a around the C axis relative to the inkjet heads 24 and the ultraviolet irradiator 25.

The controller 28 receives the information of condition settings for object shaping inputted to and received by the input receiver 12, and also receives the three-dimensional shaping information generated by the three-dimensional shaping information generator 14. Based on the received information of condition settings for object shaping and three-dimensional shaping information, the controller 28 controls the devices of the shaping part 16 to operate, including the inkjet heads 24, ultraviolet irradiator 25, carriage driver 26, and table driver 27. The controller 28 controls the operation of each inkjet head 24, including the amount of ultraviolet-curable ink to be ejected, and timing and duration of the ink ejection. The controller 28 controls the operation of the ultraviolet irradiator 25, including the intensity of ultraviolet radiation, and timing and duration of exposure. The controller 28 controls the operation of the carriage driver 26 to control relative movement of the carriage 23 in the main scanning direction. The controller 28 controls the operation of the table driver 27 to control relative movement of the table 21 in the vertical and sub scanning directions and relative movement of the table 21 around the C axis.

The controller 28 includes a storage device and a processor. The storage device includes storage means, for example, RAM, ROM, and flash memory. In the storage are stored software programs to be processed by the processor and data used for reference by the software programs. In the storage device are stored, specifically, programs run to prompt the processor to manufacture a three-dimensional object. The storage device further serves as a storage region in which processing results of the processor are temporarily stored. The processor reads the software programs from the storage device and processes the read programs to effectuate functions that depend on contents of the software programs. To be specific, the processor reads the programs from the storage device and processes the read programs to function as the controller 28 of the shaping part 16 and implements the generation of the three-dimensional shaping information of the three-dimensional object. The controller 28 may store, in the storage device, the information of condition settings for object shaping inputted to and received by the input receiver 12 and the three-dimensional shaping information generated by the three-dimensional shaping information generator 14, and may display these pieces of information on a display device provided in the controller 28. A typical example of the controller 28 may be a computer.

The three-dimensional shaping information generator 14 and the controller 28, instead of each having a storage device and a processor, may be an integral unit that accesses and uses one storage device and one processor. That is, an integrated computer may be used to effectuate functions of the three-dimensional shaping information generator 14 and the controller 28.

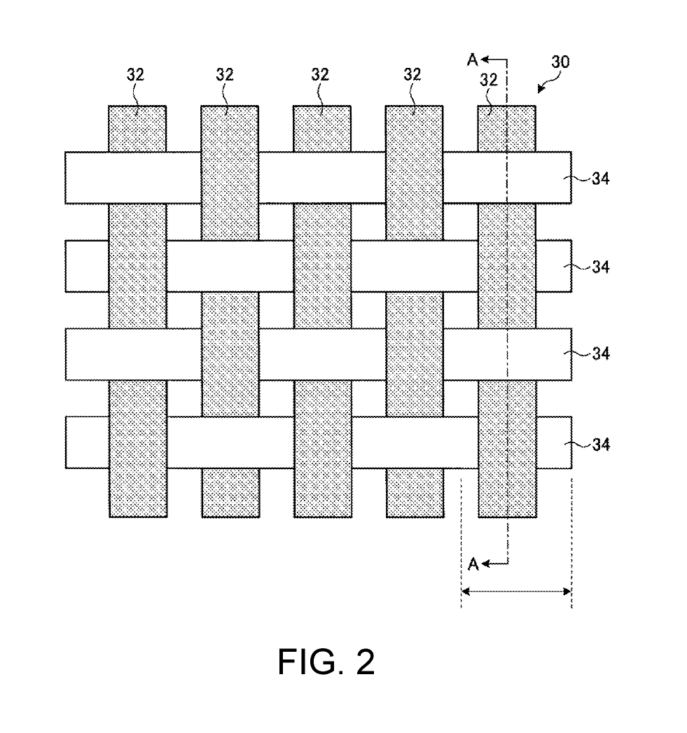

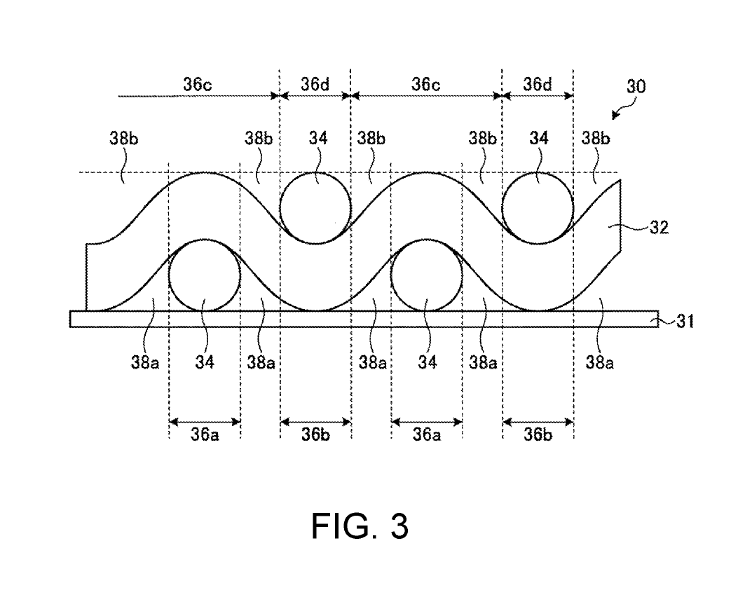

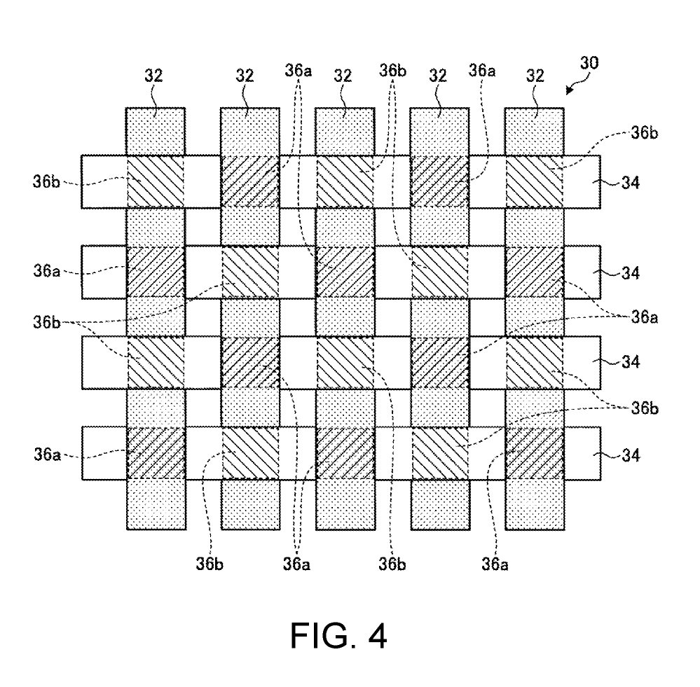

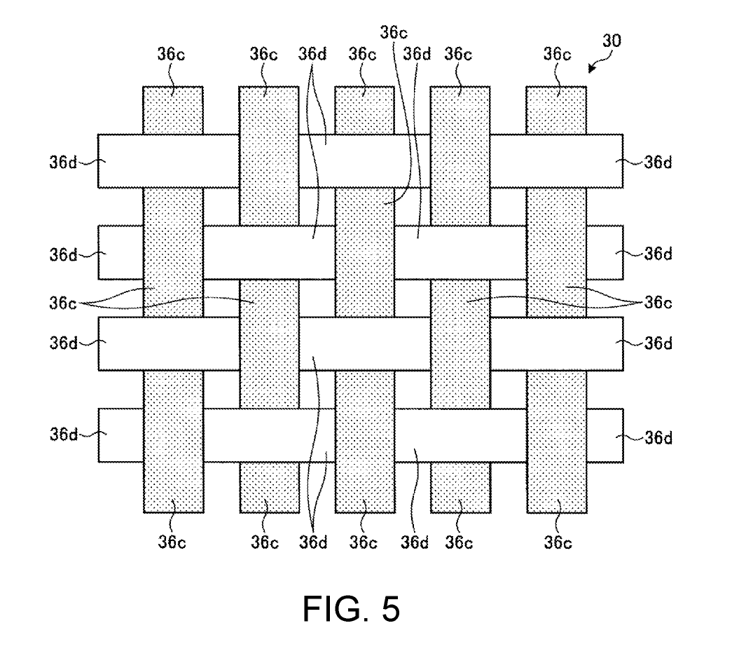

FIG. 2 is a plan view of three-dimensional shaping information 30 of a three-dimensional object processed by the three-dimensional object manufacturing apparatus 10 according to the first embodiment. FIG. 3 is an A-A cross-sectional view of the three-dimensional shaping information 30 of the three-dimensional object illustrated in FIG. 2. FIG. 4 is a drawing that illustrates a part of information processing when the three-dimensional shaping information 30 of the three-dimensional object illustrated in FIG. 2 is processed. FIG. 5 is a drawing that illustrates another part of information processing when the three-dimensional shaping information 30 of the three-dimensional object illustrated in FIG. 2 is processed.

The three-dimensional shaping information 30 includes information of a three-dimensional object structured and appearing like a textile fabric formed by interweaving a plurality of warp yarns and a plurality of weft yarns. That is, as illustrated in FIG. 2, the three-dimensional shaping information 30 of the three-dimensional object includes information of structures 32 of warp yarn vertically extending and arranged at equal intervals, and information of structures 34 of weft yarn transversely extending and arranged at equal intervals. A plane made by vertical and transverse directions in FIG. 2 extends in a direction along a plane made by X and Y axes in FIG. 1. In this embodiment, the vertical direction in FIG. 2 and the X axis in FIG. 1 coincide with each other, and the transverse direction in FIG. 2 and the Y axis in FIG. 1 coincide with each other, which is presented as a non-limiting example of this disclosure.

The information of the structures 32 of warp yarn and the structures 34 of weft yarn is based on the yarn-related information inputted to and received by the yarn-related information receiver 18. In a non-limiting example of this embodiment, two different yarn structures; structure 32 of warp yarn and structure 34 of weft yarn, are used. One type of yarn or three or more types of yarns may be used to form such structures. The structure 32 of warp yarn and the structure 34 of weft yarn may have an optional thickness. The structures of warp yarn and weft yarn are non-limiting examples of this disclosure. Other possible examples may include structures formed by interweaving obliquely extending yarns.

The weaving method for the structures 32 of warp yarn and the structures 34 of weft yarn is based on the yarn weaving method information inputted to and received by the weaving method receiver 19. According to the weaving method in this embodiment for the structures 32 of warp yarn and the structures 34 of weft yarn, the structures 32 of the warp and the structures 34 of weft yarn are arranged to be orthogonal to each other, the structures 32 of warp yarn are extending in a wave-like manner so as to run alternately on an upper side and a lower side of the structures 34 of weft yarn, and the structures 34 of weft yarn are extending in a wave-like manner so as to run alternately on an upper side and a lower side of the structures 32 of warp yarn. This weaving method is a non-limiting example of this disclosure. Optionally, structures of one type of yarn may be interwoven, structures of two types of yarns may be interwoven in a different manner to the weaving method disclosed herein, or structures of three or more types of yarns may be interwoven.

As illustrated in FIG. 3, the structures 32 of warp yarn and the structures 34 of weft yarn are disposed on the upper surface of a medium 31. The medium 31 is similar to the medium set on the working plane 21a. As illustrated in FIG. 3, the structure 32 of warp yarn may be rounded in cross section. Specifically, the structure 32 of warp yarn may have a shape in cross section similar to a shape in cross section of a real yarn, for example, circular or elliptical shape. The structure 32 of warp yarn may have a shape in cross section formed by twining a plurality of yarns, i.e., a shape in which a plurality of circular or elliptical shapes are combined. The structure 34 of weft yarn may also have a shape in cross section similar to that of the structure 32 of warp yarn. Information of shapes in cross section of the structures 32 and 34 of warp and weft yarns is included in the three-dimensional shaping information 30 of the three-dimensional shaping information.

In a case where the three-dimensional shaping information 30 of the three-dimensional object received by the controller 28 includes information of shapes in cross section of the structures 32 of warp yarn and the structures 34 of weft yarn, the shaping part 16 shapes the three-dimensional object, so that the structures 32 of warp yarn and the structures 34 of weft yarn have shapes in cross section as indicated by the information included in the three-dimensional shaping information 30 of the three-dimensional object. In a case where the three-dimensional shaping information 30 of the three-dimensional object includes information indicating that shapes in cross section of the structures 32 of warp yarn and the structures 34 of weft yarn are rounded, the shaping part 16 shapes the three-dimensional object, so that the structures 32 of warp yarn and the structures 34 of weft yarn have rounded shapes in cross section.

As illustrated in FIGS. 3 and 4, the three-dimensional shaping information 30 of the three-dimensional object may include overlap parts, in a view from the surface side, in which the structures 32 of warp yarn and the structures 34 of weft yarn overlap with each other. Specifically, the three-dimensional shaping information 30 of the three-dimensional object may include overlap parts 36a in which the structures 32 of warp yarn overlap with the structures 34 of weft yarn on the upper side of the structures 34, and overlap parts 36b in which the structures 34 of weft yarn overlap with the structures 32 of warp yarn on the upper side of the structures 32. In the three-dimensional shaping information 30 of the three-dimensional object, the overlap parts 36a and 36b both have a rectangular shape with a vertical length equal to the width of the structure 34 of weft yarn and a lateral length equal to the width of the structure 32 of warp yarn. In the three-dimensional shaping information 30 of the three-dimensional object, the overlap parts 36a and 36b are, with non-overlap parts interposed therebetween, alternately arranged vertically and transversely.

As illustrated in FIGS. 3 and 5, the three-dimensional shaping information 30 of the three-dimensional object may include warp yarn structure visible parts 36c in which the structures 32 of warp yarn are visible from the upper side, and weft yarn structure visible parts 36d in which the structures 34 of weft yarn are visible from the upper side. The warp yarn structure visible part 36c includes an overlap part 36a, and overlap parts 36b are disposed adjacently to vertical ends on both sides of the warp yarn structure visible part 36c. The warp yarn structure visible part 36c has a rectangular shape with a vertical length equal to an interval between two overlap parts 36b and a lateral length equal to the width of the structure 32 of warp yarn. The weft yarn structure visible part 36d includes an overlap part 36b, and overlap parts 36a are disposed adjacently to lateral ends on both sides of the weft yarn structure visible part 36d. The weft yarn structure visible part 36d has a rectangular shape with a vertical length equal to the width of the structure 34 of weft yarn and a lateral length equal to an interval between two overlap parts 36a. The warp yarn structure visible parts 36c and the weft yarn structure visible parts 36d are arranged alternately in vertical and transverse directions in a manner that longitudinal directions of these parts 36c and 36d are orthogonal to each other.

The three-dimensional shaping information 30 of the three-dimensional object includes voids 38a and 38b, as illustrated in FIG. 3. The void 38a is present adjacently to the structure 34 of weft yarn on the lower side of the structure 32 of warp yarn in a region between the medium 31 and the structure 32 of warp yarn. The void 38b is present adjacently to the structure 34 of weft yarn on the upper side of the structure 32 of warp yarn in a region above the structure 32 of warp yarn. The three-dimensional shaping information 30 of the three-dimensional object further includes voids that are present adjacently to the structures 32 of warp yarn on the lower side of the structures 34 of weft yarn in a region between the medium 31 and the structure 34 of weft yarn. The three-dimensional shaping information 30 of the three-dimensional object further includes voids that are present adjacently to the structures 32 of warp yarn on the upper side of the structures 34 of weft yarn in region above the structures 34 of weft yarn.

The three-dimensional shaping information 30 of the three-dimensional object may include information indicating that the three-dimensional object has a thickness in the overlap parts 36a and 36b, in a view from the surface side, greater than the thickness of a part with no overlap between the structure 32 of warp yarn and the structure 34 of weft yarn. With this information included, the shaping part 16 shapes the three-dimensional object based on the three-dimensional shaping information 30 of the three-dimensional object in which the overlap parts 36a and 36b are accentuated. This may impart an enhanced stereoscopic effect to the three-dimensional object.

The three-dimensional shaping information 30 of the three-dimensional object may include information indicating that the upper yarn structure in the overlap part has a greater thickness, for example, a thickness twice or more of that of the upper yarn structure in any part but the overlap part. Specifically, the three-dimensional shaping information 30 of the three-dimensional object may include information indicating that the structure 32 of warp yarn on the upper side in the overlap part 36a has a thickness greater than the thickness of the structure 32 of warp yarn in any part but the overlap part 36a, and the structure 34 of the weft yarn on the upper side in the overlap part 36b has a thickness greater than the thickness of the structure 34 of weft yarn in any part but the overlap part 36b. With this information included, the shaping part 16 shapes the three-dimensional object based on the three-dimensional shaping information 30 of the three-dimensional object in which the overlap parts 36a and 36b are further accentuated. This may impart a further enhanced stereoscopic effect to the three-dimensional object.

The three-dimensional shaping information 30 of the three-dimensional object may include information indicating that the upper yarn structure in the overlap part is formed in a thickness of the upper and lower yarn structures stacked in layers in the overlap part, instead of further forming the lower yarn structure in the overlap part. Specifically, the three-dimensional shaping information 30 of the three-dimensional object may include information indicating that the structure 32 of warp yarn on the upper side in the overlap part 36a is formed in a thickness of the structures 32 and 34 stacked in layers of upper and lower warp and left yarns in the overlap part 36a, instead of further forming the structure 34 of weft yarn on the lower side in the overlap part 36a, and that the structure 34 of weft yarn on the upper side in the overlap part 36b is formed in a thickness of the structures 32 and 34 stacked in layers of upper and lower weft and warp yarns in the overlap part 36b, instead of further forming the structure 32 of warp yarn on the lower side in the overlap part 36b. With this information included, the shaping part 16 shapes the three-dimensional object based on the three-dimensional shaping information 30 of the three-dimensional object in which the overlap parts 36a and 36b are further accentuated. This may impart a further enhanced stereoscopic effect to the three-dimensional object.

The three-dimensional shaping information 30 of the three-dimensional object may include information indicating that the upper yarn structure in the overlap part has a taper starting from the overlap part toward a part with no overlap between the structures of warp and weft yarns. Specifically, the three-dimensional shaping information 30 of the three-dimensional object may include information indicating that the structure 32 of upper warp yarn in the overlap part 36a has a taper starting from the overlap part 36a toward a part with no overlap between the structure 32 of warp yarn and the structure 34 of weft yarn, and the structure 34 of upper weft yarn in the overlap part 36b has a taper starting from the overlap part 36b toward a part with no overlap between the structure 32 of warp yarn and the structure 34 of weft yarn. With this information included, the shaping part 16 shapes the three-dimensional object based on the three-dimensional shaping information 30 of the three-dimensional object in which the overlap parts 36a and 36b are further accentuated. This may impart a further enhanced stereoscopic effect to the three-dimensional object.

The three-dimensional shaping information 30 of the three-dimensional object may include information of an object shaping sequence when the three-dimensional object is shaped by the shaping part 16. In a case where the three-dimensional shaping information 30 of the three-dimensional object includes overlap-related information, the object shaping sequence by the shaping part 16 starts with shaping the lower yarn structure in the overlap part and then proceeds to shaping the upper yarn structure in the overlap part. First, the structure of one of the yarns on a side closer to the working plane 21a than the structure of a main yarn among the yarns is formed, the structure of the main yarn is then formed during a scan performed along a direction in which the structure of the main yarn extends, and the structure of one of the yarns on the opposite side of the working plane 21a relative to the structure of the main yarn is finally formed. Specifically, according to the object shaping sequence of the shaping part 16, for example, the object shaping operation advances in the main scanning direction, and the shaping part 16 partly forms the structure 34 of weft yarn and the void 38a around the structure 34 in the vicinity of the overlap part 36a on the upper surface of the medium 31, then forms, on their upper side, the structure 32 of warp yarn to be continuous to the structure 34 and the void 38a, then partly forms the structure 34 of weft yarn in the vicinity of the overlap part 36b, and then integrally connects the structures 34 of weft yarn partly formed. This object shaping sequence does not include the formation of voids 38b. The three-dimensional shaping information 30 of the three-dimensional object may not necessarily include such shaping sequence-related information but may include simpler information indicating that the yarn structures are each formed and stacked in layers on the upper surface of the medium 31.

Based on information included in the three-dimensional shaping information 30 of the three-dimensional object, the shaping part 16 may form the three-dimensional object so as to have a thickness in the overlap parts 36a and 36b, in a view from the surface side, greater than the thickness of a part with no overlap between the structure 32 of warp yarn and the structure 34 of weft yarn. With this information included, the shaping part 16 shapes the three-dimensional object based on the three-dimensional shaping information 30 of the three-dimensional object in which the overlap parts 36a and 36b are accentuated. This may impart an enhanced stereoscopic effect to the three-dimensional object.

Based on information included in the three-dimensional shaping information 30 of the three-dimensional object, the shaping part 16 may form the upper yarn structure so as to have a greater thickness in the overlap part, for example, a thickness twice or more of that of the upper yarn structure in any part but the overlap part. Specifically, the shaping part 16 may form the structure 32 of upper warp yarn in the overlap part 36a in a thickness greater than the thickness of the structure 32 of warp yarn in any part but the overlap part 36a, and may form the structure 34 of upper weft yarn in the overlap part 36b in a thickness greater than the thickness of the structure 34 of weft yarn in any part but the overlap part 36b. With this information included, the shaping part 16 shapes the three-dimensional object based on the three-dimensional shaping information 30 of the three-dimensional object in which the overlap parts 36a and 36b are further accentuated. This may impart a further enhanced stereoscopic effect to the three-dimensional object.

Based on information included in the three-dimensional shaping information 30 of the three-dimensional object, the shaping part 16 may form the upper yarn structure in the overlap part so as to have a thickness of the upper and lower yarn structures stacked in layers in the overlap part, instead of further forming the lower yarn structure in the overlap part. Specifically, the shaping part 16 may form the structure 32 of upper warp yarn in the overlap part 36a so as to have a thickness of the structures 32 and 34 stacked in layers of upper warp yarn and lower weft yarn in the overlap part 36a, instead of further forming the structure 34 of lower weft yarn in the overlap part 36a, and may form the structure 34 of upper weft yarn in the overlap part 36b so as to have a thickness of the structures 34 and 32 stacked in layers of upper and lower weft and warp yarns in the overlap part 36b, instead of further forming the structure 32 of lower warp yarn in the overlap part 36b. With this information included, the shaping part 16 shapes the three-dimensional object based on the three-dimensional shaping information 30 of the three-dimensional object in which the overlap parts 36a and 36b are further accentuated. This may impart a further enhanced stereoscopic effect to the three-dimensional object.

Based on information included in the three-dimensional shaping information 30 of the three-dimensional object, the shaping part 16 may form the upper yarn structure in the overlap part so as to have a taper starting from the overlap part toward a part with no overlap between the structures of warp and weft yarns. Specifically, the shaping part 16 may form the structure 32 of upper warp yarn in the overlap part 36a so as to have a taper starting from the overlap part 36a toward a part with no overlap between the structure 32 of warp yarn and the structure 34 of weft yarn, and may form the structure 34 of upper weft yarn in the overlap part 36b so as to have a taper starting from the overlap part 36b toward a part with no overlap between the structure 32 of warp yarn and the structure 34 of weft yarn. With this information included, the shaping part 16 shapes the three-dimensional object based on the three-dimensional shaping information 30 of the three-dimensional object in which the overlap parts 36a and 36b are further accentuated. This may impart a further enhanced stereoscopic effect to the three-dimensional object.

In a case where the three-dimensional shaping information 30 of the three-dimensional object includes information of an overlap part between the structures 32 and 34 of warp and weft yarns and an object shaping sequence of the shaping part 16, the shaping part 16 starts with shaping the structure of one of the yarns on a side closer to the working plane 21a than the structure of a main yarn among the yarns, then proceeds to shaping the structure of the main yarn during a scan performed along a direction in which the structure of the main yarn extends, and finally shapes the structure of one of the yarns on a side opposite to the working plane 21a relative to the structure of the main yarn. Specifically, according to the object shaping sequence, the object shaping operation advances in the main scanning direction, the shaping part 16 starts with shaping the object in the main scanning direction, then partly forms the structure 34 of weft yarn and the void 38a around the structure 34 in the vicinity of the overlap part 36a on the upper surface of the medium 31, then forms, on their upper side, the structure 32 of warp yarn to be continuous to the structure 34 and the void 38a, then partly forms the structure 34 of weft yarn in the vicinity of the overlap part 36b, and then integrally connect the structures 34 of weft yarn partly formed.

To form the void 38a, the shaping part 16 uses an ink containing a white ink as a coloring ink, an ink containing a transparent ink, such as clear ink instead of coloring ink, an ink containing an ink having substantially the same color as the medium 31 as a coloring ink, an ink containing an ink having substantially the same color as the structure 32 or 34 of the warp or well yarn most proximate to and around the void 38a as a coloring ink, or an opaque ink described later in a second embodiment. The shaping part 16 skips the formation of voids 38b. Thus, the shaping part 16 may optimally process the voids 38a and 38b included in the three-dimensional shaping information 30 of the three-dimensional object. The shaping part 16 further forms the voids 38a on the lower side closer to the working plane 21a to support the structures 32 of warp yarn and the structures 34 of weft yarn formed on the upper side. The shaping part 16 skips the formation of uppermost voids 38b to allow the yarn structures on the upper side alone to present a real textile-like appearance.

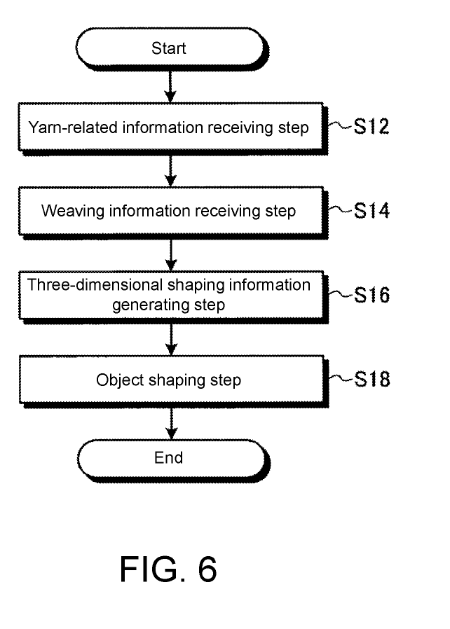

FIG. 6 is a flowchart of a manufacturing method for the three-dimensional object according to the first embodiment. The three-dimensional object manufacturing method is hereinafter described referring to FIG. 6. This is an exemplified method for operating the three-dimensional object manufacturing apparatus 10 according to the first embodiment. As illustrated in FIG. 6, the three-dimensional object manufacturing method according to the first embodiment includes a yarn-related information receiving step (Step S12), a weaving information receiving step (Step S14), a three-dimensional shaping information generating step (Step S16), and an object shaping step (Step S18).

The yarn-related information receiver 18 first receives information inputted of an optional number of yarns including one or more yarns (Step S12). Next, the weaving method receiver 19 receives information inputted of a yarn weaving method (Step S14). The input receiver 12 transmits the received information; yarn-related information inputted to and received by the yarn-related information receiver 18, and yarn weaving method inputted to and received by the weaving method receiver 19, to the three-dimensional shaping information generator 14.

Either one of Steps S12 and Step S14 may be performed earlier or later than the other. Step S12 of receiving inputted yarn-related information may be followed by Step S14 of receiving inputted information of the yarn weaving method associated with the yarn-related information received in Step S12, or Step S14 of receiving inputted information of the yarn weaving method may be followed by Step S12 of receiving inputted yarn-related information associated with the weaving method received in Step S14.

The three-dimensional shaping information generator 14 then generates the three-dimensional shaping information of the three-dimensional object based on the yarn-related information and the yarn weaving method received by the input receiver 12 (Step S16). The three-dimensional shaping information generator 14 transmits the generated three-dimensional shaping information to the controller 28 of the shaping part 16. The three-dimensional shaping information generator 14 generates the three-dimensional shaping information 30 of the three-dimensional object and transmits the generated information 30 to the controller 28 of the shaping part 16.

In Step S16, the three-dimensional shaping information generator 14 may generate a piece of three-dimensional shaping information per minimum unit based on the yarn-related information and the weaving method information and repeatedly process the piece of three-dimensional shaping information per minimum unit to generate three-dimensional shaping information of a three-dimensional object structured and sized as predefined.

In Step S16, the three-dimensional shaping information generator 14 may include information of shapes in cross section of the structure 32 of warp yarn and the structure 34 of weft yarn in the three-dimensional shaping information 30 of the three-dimensional object. In Step S16, the three-dimensional shaping information generator 14 may include information of the overlap parts 36a and 36b between the structure 32 of warp yarn and the structure 34 of weft yarn in the three-dimensional shaping information 30 of the three-dimensional object. In Step S16, the three-dimensional shaping information generator 14 may include information of the warp yarn structure visible parts 36c and the weft yarn structure visible parts 36d in the three-dimensional shaping information 30 of the three-dimensional object. In Step S16, the three-dimensional shaping information generator 14 may include information of an object shaping sequence when the object is shaped by the shaping part 16 in the three-dimensional shaping information 30 of the three-dimensional object.

Based on the three-dimensional shaping information 30 of the three-dimensional object received from the three-dimensional shaping information generator 14, the shaping part 16 ejects the ultraviolet-curable inks; object forming material, onto the working plane 21a and irradiates the ejected inks with ultraviolet light to cure the inks and shape the three-dimensional object on the working plane 21a (Step S18). Specifically, the medium 31 is set on the working plane 21a. Then, the structures 32 of warp yarn and the structures 34 of weft yarn are shaped on the medium 31 as indicated with the information included in the three-dimensional shaping information 30 of the three-dimensional object.

In a case where the three-dimensional shaping information 30 of the three-dimensional object includes information of shapes in cross section of the structure 32 of warp yarn and the structure 34 of weft yarn, the shaping part 16, in Step S18, shapes the three-dimensional object, so that the structures 32 of warp yarn and the structures 34 of weft yarn are shaped in cross section as indicated with the information. In a case where the three-dimensional shaping information 30 of the three-dimensional object includes information of an overlap part between the structure 32 of warp yarn and the structure 34 of weft yarn and information of an object shaping sequence of the shaping part 16, the shaping part 16, in Step S18, shapes the three-dimensional object as indicated with the information.

The object forming material used in Step S18 is ultraviolet-curable inks. Step S18, therefore, may skip the formation of an image layer coating conventionally used to avoid adhesion of soiled water. The three-dimensional object thus obtained may be hardly soiled.

The three-dimensional object manufacturing apparatus 10 and the three-dimensional object manufacturing method used by the apparatus 10 are characterized as described so far in that the three-dimensional object is manufactured based on the yarn-related information and the yarn weaving method. The three-dimensional object manufactured by the apparatus and method, therefore, may be hardly soiled and may appear and/or feel when touched, as if the object was a real textile fabric. The three-dimensional object manufacturing apparatus 10 and the three-dimensional object manufacturing method used by the apparatus 10 may reproduce the feel and texture of a real textile fabric on media such as plastic films, plastic plates, metal plates, glass plates, synthetic plates, wooden and synthetic building materials, unwoven fabrics, and plastic membranes. The three-dimensional object manufacturing apparatus 10 and the three-dimensional object manufacturing method used by the apparatus 10 may promise a sense of luxury, comfort, and coziness in environments where the manufactured object is used.

The three-dimensional object manufacturing apparatus 10 and the three-dimensional object manufacturing method used by the apparatus 10 may manufacture interior materials using three-dimensional objects easy to be cleaned and hardly soiled. The interior material is generally required of constant cleaning to keep a cleanly appearance. The interior materials obtainable as described herein may be useful in, for example, places that offer food, such as restaurants, which are easily soiled with oils and/or other foodstuffs. The interior materials obtainable as described herein may be further useful in, for example, rooms and cars that may be often exposed to contacts with persons.

According to the three-dimensional object manufacturing apparatus 10 and the three-dimensional object manufacturing method used by the apparatus 10, the three-dimensional shaping information 30 of the three-dimensional object includes information indicating that shapes in cross section of the yarn structures are rounded, and the three-dimensional object is shaped that the shapes in cross section of the yarn structures are rounded. The three-dimensional object in which the yarn structures are thus rounded in cross section, like real yarns, may have an appearance and texture of a real textile fabric.

Based on the three-dimensional shaping information 30 of the three-dimensional object, the three-dimensional object manufacturing apparatus 10 and the three-dimensional object manufacturing method used by the apparatus 10 may form the three-dimensional object so as to have a thickness in the overlap parts 36a and 36b, in a view from the surface side, greater than the thickness of a part with no overlap between the structure 32 of warp yarn and the structure 34 of weft yarn. Based on the three-dimensional shaping information 30 of the three-dimensional object, the three-dimensional object manufacturing apparatus 10 and the three-dimensional object manufacturing method used by the apparatus 10 may form the upper yarn structure so as to have a greater thickness in the overlap part, for example, a thickness twice or more of that of the upper yarn structure in any part but the overlap part. Based on the three-dimensional shaping information 30 of the three-dimensional object, the three-dimensional object manufacturing apparatus 10 and the three-dimensional object manufacturing method used by the apparatus 10 may form the upper yarn structure in the overlap part so as to have a thickness of the upper and lower yarn structures stacked in layers in the overlap part, instead of further forming the lower yarn structure in the overlap part. Based on the three-dimensional shaping information 30 of the three-dimensional object, the three-dimensional object manufacturing apparatus 10 and the three-dimensional object manufacturing method used by the apparatus 10 may form the upper yarn structure in the overlap part so as to have a taper starting from the overlap part toward a part with no overlap between the structure 32 of warp yarn and the structure 34 of weft yarn. Thus, the three-dimensional object manufacturing apparatus 10 and the three-dimensional object manufacturing method used by the apparatus 10 may form the three-dimensional object based on the three-dimensional shaping information 30 in which the overlap parts 36a and 36b are further accentuated or variously shaped. The three-dimensional object with variously shaped overlap parts may present an enhanced stereoscopic effect.

According to the three-dimensional object manufacturing apparatus 10 and the three-dimensional object manufacturing method used by the apparatus 10, the three-dimensional shaping information 30 of the three-dimensional object includes information of the overlap part between the yarn structures, and the apparatus and method starts with shaping the structure of one of the yarns on a side closer to the working plane 21a than the structure of a main yarn among the yarns, then proceeds to shaping the structure of the main yarn during a scan performed along a direction in which the structure of the main yarn extends, and finally shapes the structure of one of the yarns on a side opposite to the working plane 21a relative to the structure of the main yarn. According to the three-dimensional object manufacturing apparatus 10 and the three-dimensional object manufacturing method used by the apparatus 10, structures of one type of yarn may be continuously formed and shaped longitudinally continuous like real yarns. The three-dimensional object thus obtained may have an appearance and texture of a real textile fabric.

According to the three-dimensional object manufacturing apparatus 10 and the three-dimensional object manufacturing method used by the apparatus 10, the three-dimensional shaping information generator 14 generates a piece of three-dimensional shaping information per minimum unit based on the yarn-related information and the weaving method information and repeatedly processes the piece of three-dimensional shaping information per minimum unit to generate three-dimensional shaping information of a three-dimensional object structured and sized as predefined. This method and apparatus may form distinct three-dimensional objects that variously differ in shape and size.

The three-dimensional object manufacturing apparatus 10 and the three-dimensional object manufacturing method used by the apparatus 10 may form variously different three-dimensional objects having textures and appearances of real textile fabrics by using fabric-like patterns of, for example, broadcloth (poplin), printed cotton, voile, mousseline, amunzen, satin, velveteen, cotton flannel, corduroy, dobby cloth, Jacquard-woven cloth, gingham, denim, Burberry (registered trademark), cashmere, Habutae (registered trademark), chiffon, crepe, and velvet.

### Second Embodiment

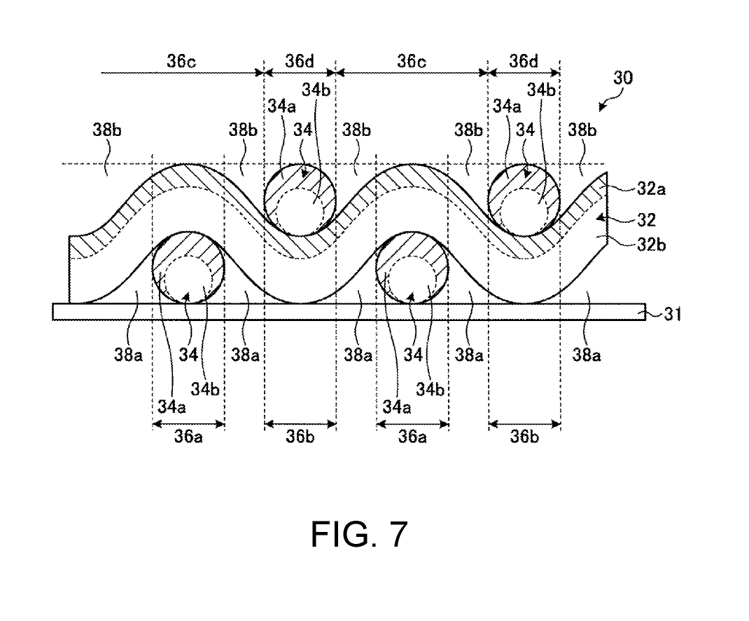

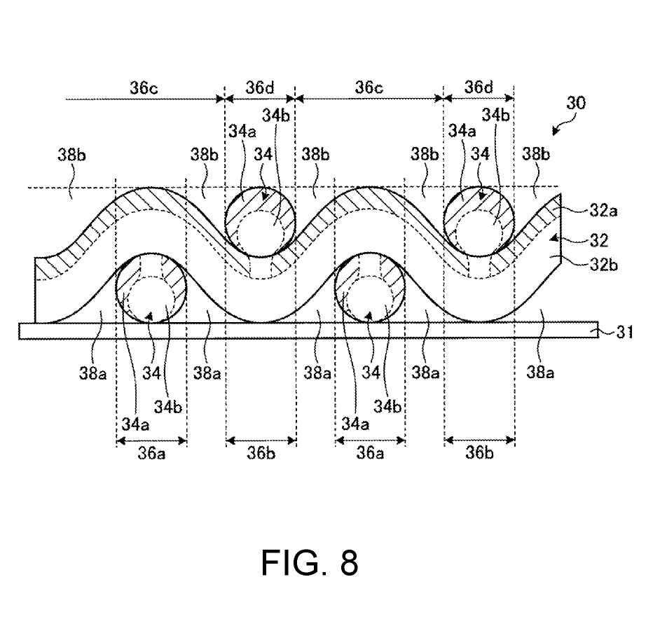

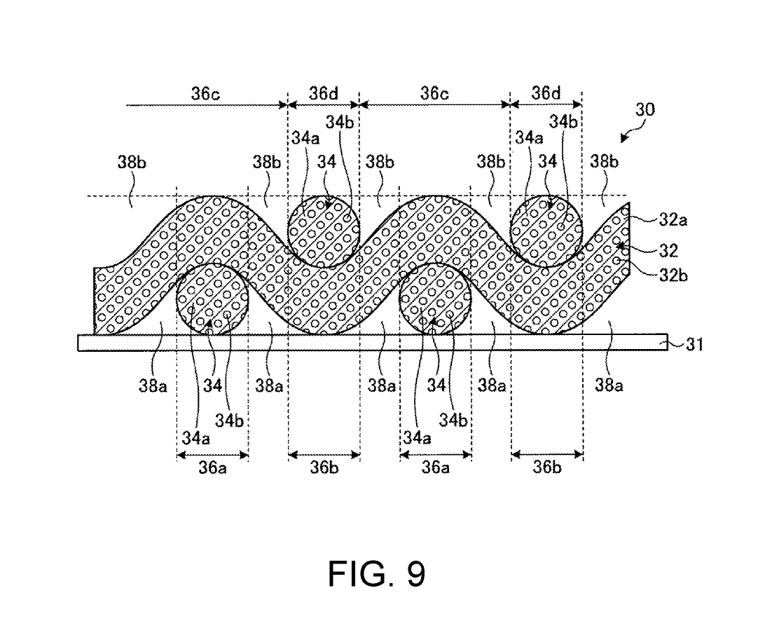

FIG. 7 is a cross-sectional view of an exemplified distribution of the coloring inks included in the object forming material in the three-dimensional shaping information 30 of the three-dimensional object according to a second embodiment. FIG. 8 is a cross-sectional view of another exemplified distribution of the coloring inks included in the object forming material in the three-dimensional shaping information 30 of the three-dimensional object according to the second embodiment. FIG. 9 is a cross-sectional view of an exemplified distribution of the coloring inks included in the object forming material in the three-dimensional shaping information 30 of the three-dimensional object according to the second embodiment. The three-dimensional object manufacturing apparatus according to the second embodiment is distinct from the three-dimensional object manufacturing apparatus 10 according to the first embodiment in that the three-dimensional shaping information generator 14 may optionally include coloring-related information in the three-dimensional shaping information of the three-dimensional object according to the three-dimensional shaping information, and the shaping part 16 shapes the three-dimensional object based on the coloring-related information. The three-dimensional shaping information 30 of the three-dimensional object according to the second embodiment is the three-dimensional shaping information 30 of the three-dimensional object according to the first embodiment further containing the coloring-related information. In the second embodiment hereinafter described, any structural elements similar to those of the first embodiment are illustrated with like reference sings and will not be described in detail.

To impart a light blocking effect to the three-dimensional object, the three-dimensional shaping information generator 14 may subject the three-dimensional shaping information of the three-dimensional object to a light blocking process that sets a region(s) where the opaque ink is usable. The three-dimensional shaping information generator 14 may include information of the opaque ink-usable region(s) in the three-dimensional shaping information 30 of the three-dimensional object. Specifically, the three-dimensional shaping information generator 14 processes the three-dimensional shaping information 30 to include the opaque ink-usable region(s) in a partial region of the structures 32 of warp yarn so that light does not transmit through the medium 31 and the structures 34 of weft yarn on the lower side of the structures 32 of warp yarn in the warp yarn structure visible parts 36c, and to include the opaque ink-usable region(s) in a partial region of the structures 34 of weft yarn so that light does not transmit through the medium 31 and the structures 32 of warp yarn on the lower side of the structures 34 of weft yarn in the weft yarn structure visible parts 36d. For example, the three-dimensional shaping information generator 14 may generate such three-dimensional shaping information 30 of the three-dimensional object, examples of which are illustrated in FIGS. 7, 8, and 9.

In the three-dimensional shaping information 30 of the three-dimensional object according to the second embodiment, the structure 32 of warp yarn includes two coloring ink regions 32a and 32b, and the structure 34 of weft yarn includes two coloring ink regions 34a and 34b, as illustrated in FIGS. 7, 8, and 9.

Specifically, in the three-dimensional shaping information 30 of the three-dimensional object illustrated in FIG. 7, the region 32a is a visually recognizable part of the structure 32 of warp yarn that lies on the opposite side of the medium 31, and the region 32b is a visually unrecognizable part of the structure 32 of warp yarn that lies on the medium 31 side. In the three-dimensional shaping information 30 of the three-dimensional object illustrated in FIG. 7, the region 34a is a visually recognizable part of the structure 34 of weft yarn that lies on the opposite side of the medium 31, and the region 34b is a visually unrecognizable part of the structure 34 of weft yarn that lies on the medium 31 side.

In the region 32a is used a coloring ink having the original color of the structure 32 of warp yarn. In the region 32b is used an opaque ink to block light from transmitting therethrough, so that colors of, for example, the medium 31 and the structure 34 of weft yarn below the structure 32 of warp yarn are not visually perceived. The opaque ink scatters light not to block light from transmitting therethrough.

In the region 34a is used a coloring ink having the original color of the structure 34 of weft yarn. In the region 34b is used an opaque ink to block light from transmitting therethrough, so that colors of, for example, the medium 31 and the structure 32 of warp yarn below the structure 34 of weft yarn are not visually perceived. In the three-dimensional shaping information 30 of the three-dimensional object illustrated in FIG. 7, the regions 32a and 32b are both extending uninterruptedly along the direction in which the structure 32 of warp yarn is extending. In the three-dimensional shaping information 30 of the three-dimensional object illustrated in FIG. 7, the regions 34a and 34b are both extending uninterruptedly along the direction in which the structure 34 of weft yarn is extending. In the three-dimensional shaping information 30 of the three-dimensional object illustrated in FIG. 7, therefore, the region 32a covers the whole horizontal surface on one side of the structure 32 of warp yarn opposite to the medium 31, while the region 32b covers the whole horizontal surface on the other side of the structure 32 of warp yarn closer to the medium 31. In the three-dimensional shaping information 30 of the three-dimensional object illustrated in FIG. 7, the region 34a covers the whole horizontal surface on one side of the structure 34 of weft yarn opposite to the medium 31, while the region 34b covers the whole horizontal surface on the other side of the structure 34 of weft yarn closer to the medium 31.

The three-dimensional shaping information 30 of the three-dimensional object illustrated in FIG. 8 differs from the three-dimensional shaping information 30 of the three-dimensional object illustrated in FIG. 7 in that the region 34b in the weft yarn structure visible part 36d extends downward and penetrates through the region 32a to be integrally connected to the region 32b, and the region 32b in the warp yarn structure visible part 36c extends downward and penetrates through the region 34a to be integrally connected to the region 34b.

The three-dimensional shaping information 30 of the three-dimensional object illustrated in FIG. 9 differs from the three-dimensional shaping information 30 of the three-dimensional object illustrated in FIG. 7 in that the regions 32a and 32b are combined, and the regions 34a and 34b are combined. In the three-dimensional shaping information 30 of the three-dimensional object illustrated in FIG. 9, the region 32b is substantially evenly distributed in the region 32a of the structure 32 of warp yarn, and the region 34b is substantially evenly distributed in the region 34a of the structure 34 of weft yarn. Also in the three-dimensional shaping information 30 of the three-dimensional object illustrated in FIG. 9, the region 32a covers the whole horizontal surface on one side of the structure 32 of warp yarn opposite to the medium 31, the region 34a covers the whole horizontal surface on one side of the structure 34 of weft yarn opposite to the medium 31, and the regions 32a and 34a are both visually recognizable.

The opaque ink contains a white pigment and thereby exerts a light blocking effect. The opaque ink may be a white ink not containing any coloring pigment but the white pigment, or may be a coloring ink containing any coloring pigment but the white pigment. The white pigment added to the opaque ink may have a haze value; opacity indicator, more than or equal to 30%, preferably more than or equal to 70%, and further preferably more than equal to 90%. The haze value is expressed in the following formula 1.

Haze value [%]=(transmitted light with scattering component alone/whole transmitted light)×100 Formula 1

A sample used for the measurement was a transparent polyester film or a glass plate with two films formed thereon by solid printing twice the ink disclosed herein according to a known ultraviolet-curable ink printing method. Then, the haze value was measured by a haze meter (MDH-2000 supplied by NIPPON DENSHOKU INDUSTRIES Co., LTD.) according to a method pursuant to JIS K7105.

The opaque ink contains a white pigment. The white pigment may include any one selected from a hollow white pigment, micro-encapsulated titanium oxide, micro-encapsulated zinc oxide, and nanoparticles having an average particle size less than or equal to 300 nm. The average particle size refers to an arithmetic mean of the volume and diameter of a particle.

Examples of the hollow white pigment may include hollow or porous particulate polymers. The hollow or porous particulate polymer has large voids in its structure and is characterized by low light transmittance, relatively high light blocking effect against visible light, and small specific gravity. The hollow or porous particulate polymers may be obtainable by using alkali-swollen materials such as carboxylate-containing monomers, by heating base-added particles copolymerized with unsaturated carboxylic acid and adding acid to and neutralizing the resulting particles to be swollen, by adding methyl methacrylate and cross-linking monomer to polymerized polystyrene seed particles and adding an aqueous initiator to the resulting swollen particles, by drying foaming agent- or volatile material-containing polymer particles to volatilize and foam the particles, by polymerizing the oil layer of a water/oil/water (W/O/W) monomer emulsion, by two-step polymerization of monomers that differ in compatibility, or by removing oil-based component from the pores of synthesized polymer obtained by suspension polymerization or emulsion polymerization of a dispersion liquid containing the oil-based component, hydrophilic monomer, and cross-linking monomer by a certain proportion.

The micro-encapsulated titanium oxide is micro-encapsulated pigment particles of titanium oxide having an average particle size less than or equal to 300 nm. The micro-encapsulated zinc oxide is micro-encapsulated pigment particles of zinc oxide having an average particle size less than or equal to 300 nm. The “micro-encapsulation” may refer to coating a particle with a thin coating film, which may stabilize particle dispersion and prevent particle aggregation to suppress specific gravity.

All of the mentioned examples of the white pigment are smaller in specific gravity than the known white pigments such as titanium oxide and zinc oxide and are equal in specific gravity to the coloring pigment and other components included in the coloring ink. The white pigments thus characterized may be unlikely to precipitate in the coloring pigment and other components included in the coloring ink and may remain in stable condition in the three-dimensional object. Such white pigments may be less likely to be isolated due to a difference in specific gravity to the coloring pigment and other components included in the coloring ink and may remain well-mixed with the coloring pigment and other components included in the coloring ink. This may stabilize the ink ejection and ink color tone. As a result, a three-dimensional object substantially equal in opacity to real textile fabrics may be successfully manufactured.

The three-dimensional shaping information generator 14 may subject the three-dimensional shaping information 30 of the three-dimensional object to a minimum required light blocking process enough to prevent color mixing between the structures 32 of warp yarn and the structures 34 of weft yarn. Specifically, parts required of such a light blocking process may be parts included in the warp yarn structure visible parts 36c of the structures 32 of warp yarn and parts included in the weft yarn structure visible parts 36d of the structures 34 of weft yarn. FIGS. 7, 8, and 9 illustrate non-limiting examples of the three-dimensional shaping information 30 of the three-dimensional object according to the second embodiment. Any other types of three-dimensional shaping information 30 of the three-dimensional object may be usable insofar as they have been subjected to such a minimum required light blocking process enough to prevent color mixing between the structures 32 and 34 of warp and weft yarns.

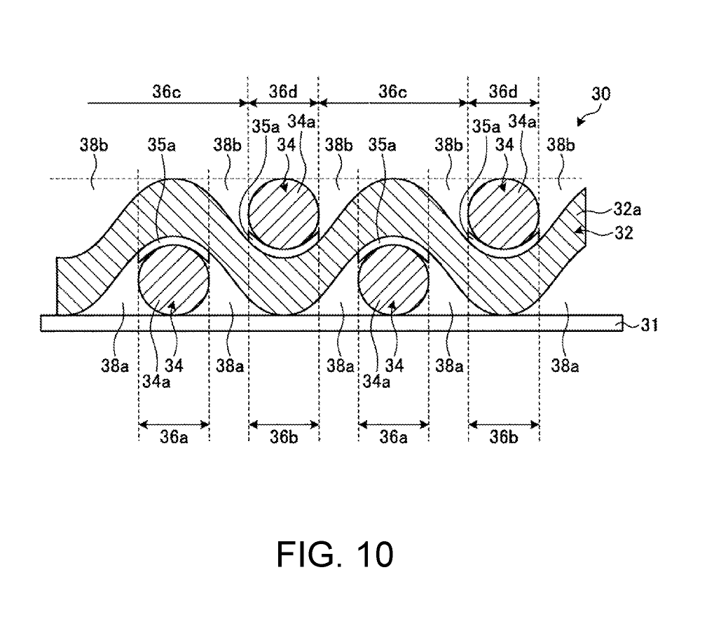

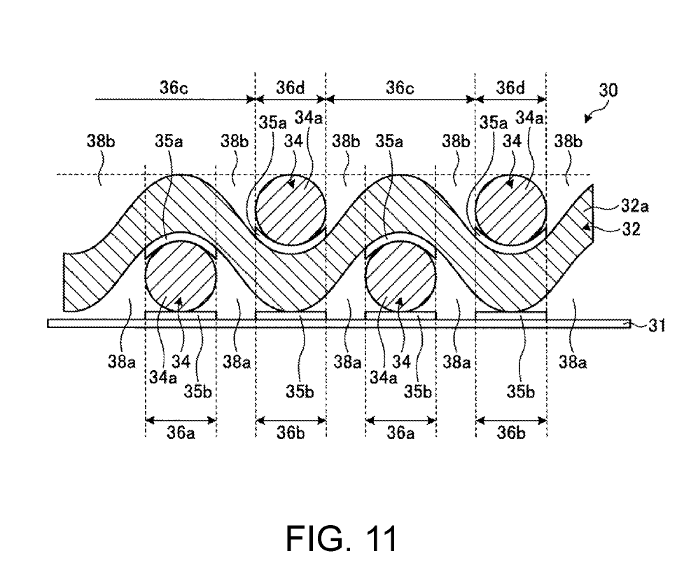

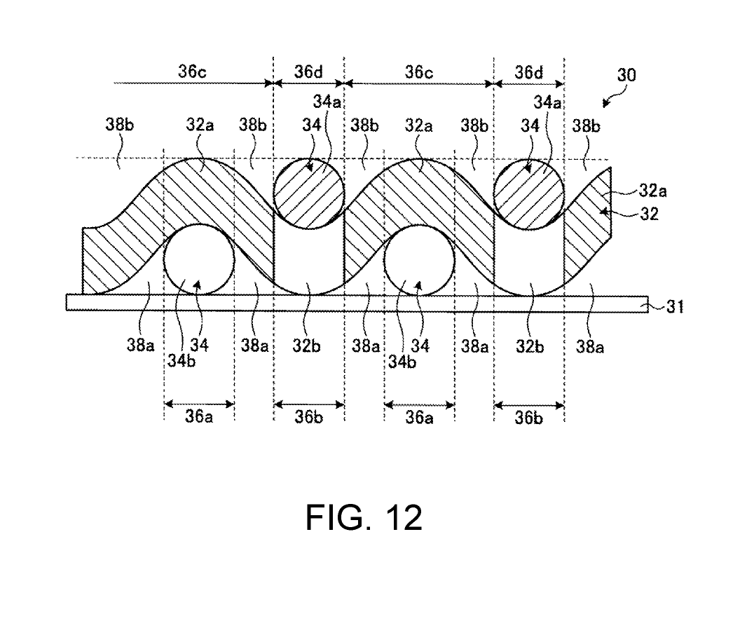

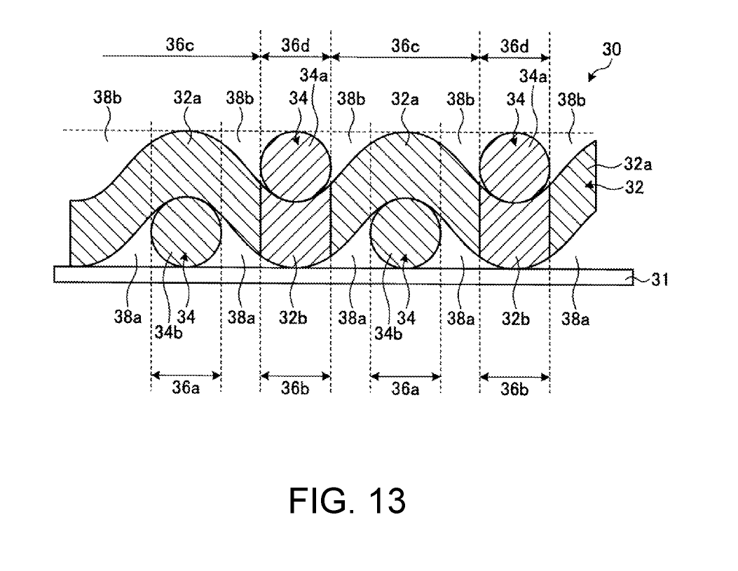

FIG. 10 is a cross-sectional view of still another exemplified distribution of the coloring inks included in the object forming material in the three-dimensional shaping information 30 of the three-dimensional object according to the second embodiment. FIG. 11 is a cross-sectional view of still another exemplified distribution of the coloring inks included in the object forming material in the three-dimensional shaping information 30 of the three-dimensional object according to the second embodiment. FIG. 12 is a cross-sectional view of still another exemplified distribution of the coloring inks included in the object forming material in the three-dimensional shaping information 30 of the three-dimensional object according to the second embodiment. FIG. 13 is a cross-sectional view of still another exemplified distribution of the coloring inks included in the object forming material in the three-dimensional shaping information 30 of the three-dimensional object according to the second embodiment. Modified examples of the three-dimensional shaping information 30 of the three-dimensional object according to the second embodiment are hereinafter described referring to FIGS. 10 to 13.

The three-dimensional shaping information 30 of the three-dimensional object illustrated in FIG. 10 is distinct from the three-dimensional shaping information 30 of the three-dimensional object illustrated in FIGS. 7, 8, and 9 in that, instead of the regions 32a and 32b in the structure 32 of warp yarn and the regions 34a and 34b in the structure 34 of weft yarn, white ink layers 35a are interposed between the structures 32 of warp yarn and the structures 34 of weft yarn in the overlap parts 36a and 36b. According to the three-dimensional shaping information 30 of the three-dimensional object illustrated in FIG. 10, specifically, the white ink layers 35a are respectively interposed between one side of the structure 32 of warp yarn closer to the medium 31 and one side of the structure 34 of weft yarn opposite to the medium 31 in the overlap part 36a, and between one side of the structure 34 of weft yarn closer to the medium 31 and one side of the structure 32 of warp yarn opposite to the medium 31 in the overlap part 36b.

The white ink layer 35a included in the three-dimensional shaping information 30 of the three-dimensional object illustrated in FIG. 10 includes the white pigment described earlier. The white ink layer 35a may be colored to an extent that does not affect colors of the structures 32 of warp yarn and the structures 34 of weft yarn. The three-dimensional shaping information 30 of the three-dimensional object illustrated in FIG. 10 including the white ink layers 35a has been subjected to the light blocking process, similarly to the three-dimensional shaping information 30 of the three-dimensional object illustrated in FIGS. 7, 8, and 9.

The three-dimensional shaping information 30 of the three-dimensional object illustrated in FIG. 11 is distinct from the three-dimensional shaping information 30 of the three-dimensional object illustrated in FIG. 10 in that white ink layers 35b are further provided, which are respectively interposed between the structure 34 of weft yarn and the medium 31 in the overlap part 36a, and between the structure 32 of warp yarn and the medium 31 in the overlap part 36b. The three-dimensional shaping information 30 of the three-dimensional object illustrated in FIG. 11 includes white ink layers 35a similarly to the three-dimensional shaping information 30 of the three-dimensional object illustrated in FIG. 10, white ink layers 35b between the structures 34 of weft yarn and the medium 31 in the overlap parts 36a, and white ink layers 35b between the structures 32 of warp yarn and the medium 31 i1 in the overlap parts 36b.

The white ink layer 35b included in the three-dimensional shaping information 30 of the three-dimensional object illustrated in FIG. 11 includes the white pigment described earlier, similarly to the white ink layer 35a. Similarly to the white ink layer 35a, the white ink layer 35b may be colored to an extent that does not affect colors of the structures 32 of warp yarn and the structures 34 of weft yarn. In the three-dimensional shaping information 30 of the three-dimensional object illustrated in FIG. 11 further including the white ink layers 35b, the medium 31 has been subjected to the light blocking process in the overlap parts 36a and 36b.

According to the three-dimensional shaping information 30 of the three-dimensional object illustrated in FIG. 12, how to divide the structure 32 of warp yarn into the regions 32a and 32b and how to divide the structure 34 of weft yarn into the regions 34a and 34b have been changed, as compared to the three-dimensional shaping information 30 of the three-dimensional object illustrated in FIGS. 7, 8, and 9, and the structures 32 and 34 of warp and weft yarns are respectively divided in different manners. In the three-dimensional shaping information 30 of the three-dimensional object illustrated in FIG. 12, the region 32a is a part of the structure 32 of warp yarn included in the warp yarn structure visible part 36c, and the region 32b is a part of the structure 32 of warp yarn included in the weft yarn structure visible part 36d. Further, the region 34a is a part of the structure 34 of weft yarn included in the weft yarn structure visible part 36d, and the region 34b is a part of the structure 34 of weft yarn included in the warp yarn structure visible part 36c. The three-dimensional shaping information 30 of the three-dimensional object illustrated in FIG. 12 thus characterized has been subjected to the light blocking process, similarly to the three-dimensional shaping information 30 of the three-dimensional object illustrated in FIGS. 7, 8, 9, 10, and 11.

The three-dimensional shaping information 30 of the three-dimensional object illustrated in FIG. 13 is distinct from the three-dimensional shaping information 30 of the three-dimensional object illustrated in FIG. 12 in that a coloring ink having the same color as the region 34a is used for the region 32b, and a coloring ink having the same color as the region 32a is used for the region 34b. In the three-dimensional shaping information 30 of the three-dimensional object illustrated in FIG. 13, the regions colored with coloring inks having the same color are stacked in layers in both of the overlap parts 36a and 36b. Supposing that the opaque ink is unused, this three-dimensional shaping information 30 of the three-dimensional object has substantially been subjected to the light blocking process, which differs from the light blocking process in the three-dimensional shaping information 30 of the three-dimensional object illustrated in FIG. 7, 8, 9, 10, 11, or 12. The three-dimensional shaping information 30 of the three-dimensional object illustrated in FIG. 13 is similar to different pieces of the three-dimensional shaping information 30 described in the corresponding paragraphs.

The shaping part 16 shapes the three-dimensional object based on the three-dimensional shaping information 30 of the three-dimensional object that has been subjected to the light blocking process by the three-dimensional shaping information generator 14. In a case where the object shaping is based on, for example, the three-dimensional shaping information 30 of the three-dimensional object illustrated in FIG. 7, 8, 10, 11, or 12, the shaping part 16 forms, in the structure 32 of warp yarn, the region 32b using the object forming material containing the opaque ink and then forms the region 32a using the object forming material containing the coloring ink having the original color of the structure 32, and forms, in the structure 34 of weft yarn, the region 34b using the object forming material containing the opaque ink and then forms the region 34a using the object forming material containing the coloring ink having the original color of the structure 34. In a case where the object shaping is based on, for example, the three-dimensional shaping information 30 of the three-dimensional object illustrated in FIG. 9, the shaping part 16 shapes the structure 32 of warp yarn using the object forming material containing both of the opaque ink and the coloring ink having the original color of the structure 32, and shapes the structure 34 of weft yarn using the object forming material containing both of the opaque ink and the coloring ink having the original color of the structure 34. In a case where the object shaping is based on, for example, the three-dimensional shaping information 30 of the three-dimensional object illustrated in FIG. 13, the shaping part 16 can shape the structures 32 of warp yarn and the structures 34 of weft yarn without the need to use the opaque ink, as described in the first embodiment.

A three-dimensional object manufacturing method is hereinafter described. This method is an exemplified method for operating the three-dimensional object manufacturing apparatus according to the second embodiment. The three-dimensional object manufacturing method according to the second embodiment includes, as with the manufacturing method according to the first embodiment, a yarn-related information receiving step (Step S12), a weaving information receiving step (Step S14), a three-dimensional shaping information generating step (Step S16), and an object shaping step (Step S18).

Steps S12 and S14 according to the second embodiment are similar to Steps S12 and S14 according to the first embodiment. Step S16 according to the second embodiment is distinct from Step S16 according to the first embodiment in that the three-dimensional shaping information generator 14 subjects the three-dimensional shaping information 30 of the three-dimensional object to the light blocking process to prevent color mixing between the structures 32 of warp yarn and the structures 34 of weft yarn. The three-dimensional shaping information generator 14 may further subject the three-dimensional shaping information 30 of the three-dimensional object to another light blocking process to prevent the color of the medium 31 from affecting the other colors.

Step S18 of the second embodiment is distinct from Step S18 of the first embodiment in that the shaping part 16 shapes the three-dimensional object based on the three-dimensional shaping information 30 of the three-dimensional object that has been subjected to the light blocking process by the three-dimensional shaping information generator 14 to manufacture a three-dimensional object to which the light blocking process has been applied.

The three-dimensional object manufacturing apparatus according to the second embodiment and the three-dimensional object manufacturing method used by this apparatus are characterized as described so far and may accordingly provide effects similar to the three-dimensional object manufacturing apparatus 10 according to the first embodiment and the three-dimensional object manufacturing method used by the apparatus 10. In addition to the effects, the three-dimensional object manufacturing apparatus according to the second embodiment and the three-dimensional object manufacturing method used by this apparatus is further characterized in that the three-dimensional shaping information generator 14 sets an opaque ink-usable region in the three-dimensional shaping information 30 of the three-dimensional object to apply the light blocking process, and the shaping part 16 shapes the three-dimensional object based on the three-dimensional shaping information 30 of the three-dimensional object to which the light blocking process has been applied. This may provide a three-dimensional object with an improved light blocking effect that reduces the possibility that any color on the lower side is visually perceived on the upper side.

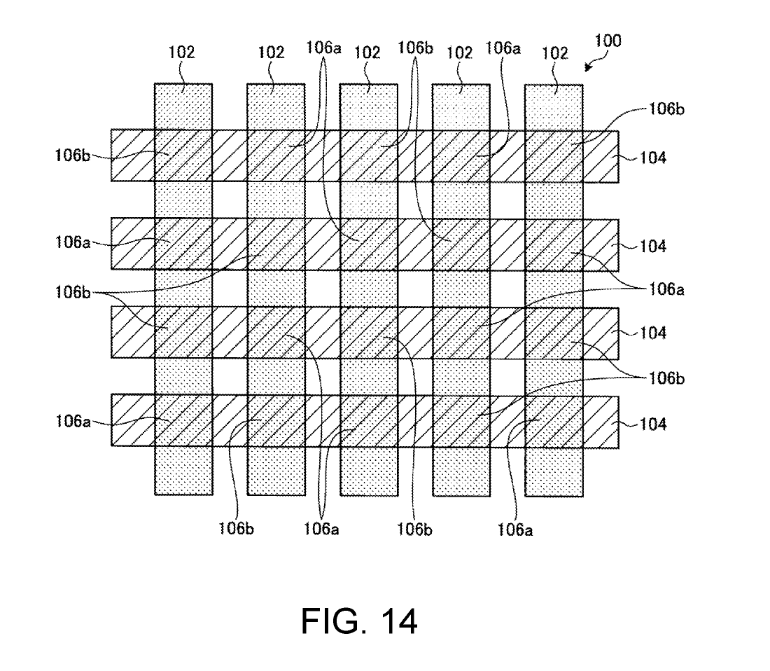

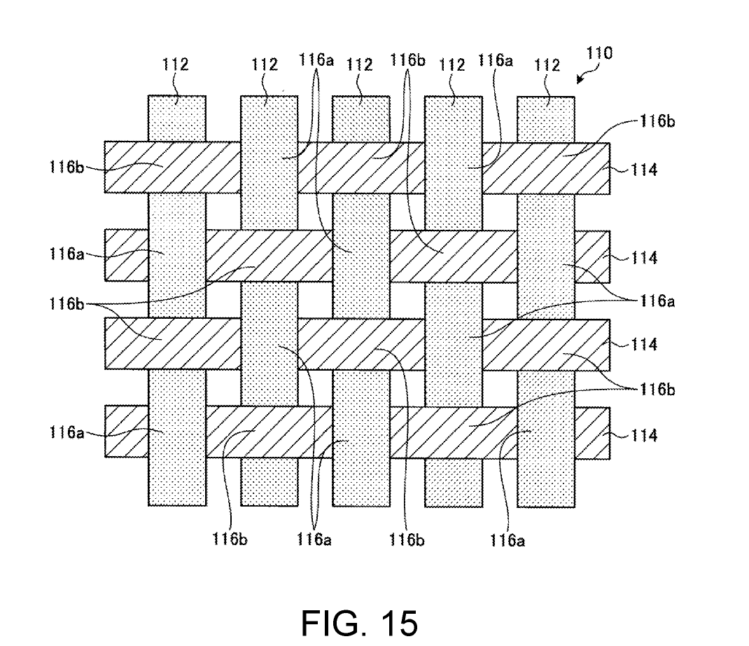

FIG. 14 is a plan view of an exemplified three-dimensional object 100 which is an example of the three-dimensional object according to the first embodiment. FIG. 15 is a plan view of an exemplified three-dimensional object 110 which is an example of the three-dimensional object according to the second embodiment. The three-dimensional object 100 is shaped based on the three-dimensional shaping information 30 of the three-dimensional object according to the first embodiment, that is, the three-dimensional object 100 is shaped without an opaque ink-usable region being set in the three-dimensional shaping information 30 of the three-dimensional object. The three-dimensional object 110 is shaped based on the three-dimensional shaping information 30 of the three-dimensional object according to the second embodiment, that is, the three-dimensional object 110 is shaped after an opaque ink-usable region is set in the three-dimensional shaping information 30 of the three-dimensional object.

As illustrated in FIG. 14, the three-dimensional object 100 includes a plurality of structures 102 of first yarn, and a plurality of structures 104 of second yarn. The structures 102 of first yarn are formed by ejecting and curing the object forming material. The structures 102 of first yarn are extending in a direction; vertical direction, in FIG. 14, and are arranged transversely in FIG. 14. The structures 104 of second yarn are formed by ejecting and curing the object forming material. The structures 104 of second yarn are extending in another direction intersecting with the direction of the structures 102 of first yarn; transverse direction, in FIG. 14, and are arranged vertically in FIG. 14. This embodiment describes the three-dimensional object 100 in which the structures 102 of first yarn and the structures 104 of second yarn are orthogonal to each other. This is a non-limiting example of the three-dimensional object. The structures 102 and 104 of first and second yarns may be arranged otherwise insofar as the structures 102 and 104 are not parallel to but are intersecting with each other. The structures 102 of first yarn and the structures 104 of second yarn are interwoven in this the three-dimensional object.

The structures 102 of first yarn are stereoscopically extending in a wave-like manner so as to run alternately on the upper side and on the lower side of the structures 104 of second yarn, i.e., run alternately on the front side and on the rear side on the drawing of FIG. 14. The structures 104 of second yarn are stereoscopically extending in a wave-like manner so as to run alternately on the upper side and on the lower side of the structures 102 of first yarn. The structures 102 of first yarn run above the structures 104 of second yarn in overlap parts 106a, i.e., the structures 104 of second yarn run below the structures 102 of first yarn in the overlap parts 106a. The structures 102 of first yarn run above the structures 104 of second yarn in overlap parts 106b, i.e., the structures 104 of second yarn run below the structures 102 of first yarn in the overlap parts 106b.

The structures 102 of first yarn are shaped based on the structures 32 of warp yarn. The structures 104 of second yarn are shaped based on the structures 34 of weft yarn. The overlap parts 106a are formed correspondingly to the overlap parts 36a. The overlap parts 106b are formed correspondingly to the overlap parts 36b.

The three-dimensional object 100 is shaped without the opaque ink being used and without an opaque ink-usable region being set in the three-dimensional shaping information 30 of the three-dimensional object. In the three-dimensional object 100, colors of the structures 102 and 104 of first and second yarns may be both visually perceived in the overlap parts 106a and 106b. This three-dimensional object, therefore, may be visually presented in coloration created by different colors of the structures 102 and 104 of first and second yarns. By coloring the structures of first and second yarns in two different colors, therefore, the three-dimensional object 100 may be exhibited in three different colors.

In a case where the three-dimensional object 100 is formed on a medium, the color and/or pattern of the medium may also be visually perceived. This three-dimensional object, therefore, may be visually presented in coloration created by different colors of the structures 102 and 104 of first and second yarns on which the color and pattern of the medium are superimposed.

As illustrated in FIG. 15, the three-dimensional object 110 includes a plurality of structures 112 of first yarn, and a plurality of structures 114 of second yarn. The three-dimensional object 110 is shaped similarly to the three-dimensional object 100. The similar features between these three-dimensional objects are compared and described below, and any detailed shape-related description will be omitted. The structures 112 of first yarn are formed correspondingly to the structures 102 of first yarn. The structures 114 of second yarn are formed correspondingly to the structures 104 of second yarn. The overlap parts 116a are formed correspondingly to the overlap parts 106a. The overlap parts 116b are formed correspondingly to the overlap parts 106b.

The three-dimensional object 110 differs in coloration from the three-dimensional object 100. The three-dimensional object 110 is shaped with the opaque ink being used and with an opaque ink-usable region being set in the three-dimensional shaping information 30 of the three-dimensional object. In the three-dimensional object 110, the structures 112 of first yarn include the opaque ink in the overlap parts 116a, while the structures 114 of second yarn include the opaque ink in the overlap parts 116b. In the three-dimensional object 110, therefore, the opaque ink may shield the color of the structure 114 of second yarn in the overlap part 116a, allowing the color of the structure 112 of first yarn to be visually perceived. In the three-dimensional object 110, the opaque ink shields the color of the structure 112 of first yarn in the overlap part 116b, allowing the color of the structure 114 of second yarn to be visually perceived. By using the opaque ink in predetermined regions, the three-dimensional object 110 may present coloration obtained by interweaving one of the two different yarns alternately on the upper side and on the lower side of the other.

In a case where the three-dimensional object 110 is formed on a medium, the opaque ink may shield the color and/or pattern of the medium. This three-dimensional object, without being affected by the color and pattern of the medium, may be visually presented in coloration created by the structures 112 and 114 of first and second yarns in which two differently colored yarns are interwoven so that one of the yarns run alternately on the upper side and on the lower side of the other.

### Third Embodiment

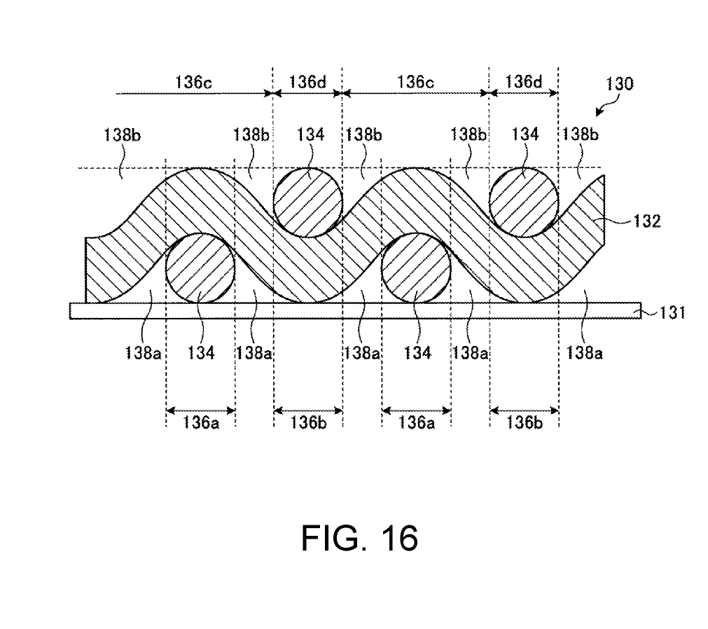

FIG. 16 is a cross-sectional view view of an exemplified three-dimensional object 130 according to a third embodiment. The three-dimensional object 130 according to the third embodiment is shaped by using an object forming material that differs from the material used in the three-dimensional objects 100 and 110 described in the second embodiment. In the third embodiment hereinafter described, any structural elements similar to those of the second embodiment are illustrated with like reference sings and will not be described in detail.

As illustrated in FIG. 16, the three-dimensional object 130 includes a plurality of structures 132 of first yarn, and a plurality of structures 134 of second yarn. The structures 132 of first yarn are formed by ejecting an object forming material consisting of an opaque color ink onto the upper surface of a medium 131 and curing the material on the medium. The structures 132 of first yarn are extending in a direction; transverse direction in FIG. 16, and are arranged in a direction perpendicular to the drawing of FIG. 16. The structures 134 of second yarn are formed by ejecting and curing an object forming material consisting of an opaque color ink. The structures 134 of second yarn are extending in another direction intersecting with the direction of the structures 132 of first yarn; a direction perpendicular to the drawing of FIG. 16, and are arranged transversely in FIG. 16. This embodiment describes the three-dimensional object 130 in which the structures 132 and 134 of first and second yarns are orthogonal to each other. This is a non-limiting example of the three-dimensional object. The structures 132 and 134 of first and second yarns may be arranged otherwise insofar as the structures 132 and 134 are not parallel to but are intersecting with each other. The structures 132 and 134 of first and second yarns are interwoven in this three-dimensional object.

The structures 132 of first yarn are stereoscopically extending in a wave-like manner so as to run alternately on the upper side of the structures 134 of second yarn (upper side in FIG. 16) and on the lower side of the structures 134 of second yarn (lower side in FIG. 14). The structures 134 of second yarn are stereoscopically extending in a wave-like manner so as to run alternately on the upper side and on the lower side of the structures 132 of first yarn. The structures 132 of first yarn run above the structures 134 of second yarn in overlap parts 136a, i.e., the structures 134 of second yarn run below the structures 132 of first yarn in overlap parts 136b. The structures 132 of first yarn run below the structures 134 of second yarn in the overlap parts 136b, i.e., the structures 134 of second yarn run above the structures 132 of first yarn in the overlap parts 136b.

The structures 132 of first yarn are shaped based on the structures 32 of warp yarn. The structures 134 of second yarn are shaped based on the structures 34 of weft yarn. The overlap parts 136a are formed correspondingly to the overlap parts 36a. The overlap parts 136b are formed correspondingly to the overlap parts 36b.

As illustrated in FIG. 16, the three-dimensional object 130 includes warp yarn structure visible parts 136c in which the structures 132 of first yarn are visible from the upper side, and weft yarn structure visible parts 136d in which the structures 134 of second yarn are visible from the upper side. The warp yarn structure visible part 136c is formed correspondingly to the warp yarn structure visible part 36c. The weft yarn structure visible part 136d is formed correspondingly to the weft yarn structure visible part 36d.

As illustrated in FIG. 16, the three-dimensional object 130 includes voids 138a and 138b. The voids 138a are formed correspondingly to the voids 38a. The voids 138b are formed correspondingly to the voids 38b.

The object forming material consisting of an opaque color ink used to form the structures 132 of first yarn is a type of opaque ink, an example of which is the ultraviolet-curable ink containing a coloring ink described in the first embodiment in which the white pigment described in the second embodiment is added and evenly dispersed. An example of the object forming material consisting of an opaque color ink used to form the structures 134 of second yarn is an ink that differs in color to the object forming material consisting of an opaque color ink used to form the structures 132 of first yarn but is similar in composition in any aspects but coloring to the object forming material consisting of an opaque color ink used to form the structures 132 of first yarn.

The three-dimensional object 130 and the manufacturing apparatus and method for the three-dimensional object 130 according to the third embodiment provide the structures 132 and 134 of first and second yarns that are interwoven by using two types of opaque color inks alone, and therefore, may obtain substantially the same effects as the light blocking process, without actually applying the light blocking process to the three-dimensional shaping information 30 of the three-dimensional object as in the second embodiment. The three-dimensional object 130 and the manufacturing apparatus and method for the three-dimensional object 130 according to the third embodiment may dispense with the light blocking process required of the three-dimensional shaping information 30 of the three-dimensional object as described in the second embodiment. This may facilitate the step of the three-dimensional shaping information 30 of the three-dimensional object being generated by the three-dimensional shaping information generator 14 (Step S16) and the step of the three-dimensional object 130 being shaped by the shaping part 16 (Step S18). As a result, the three-dimensional shaping information 30 of the three-dimensional object may be reduced in volume, and the operation to shape the three-dimensional object 130 may be easily controlled and carried out.

### Fourth Embodiment

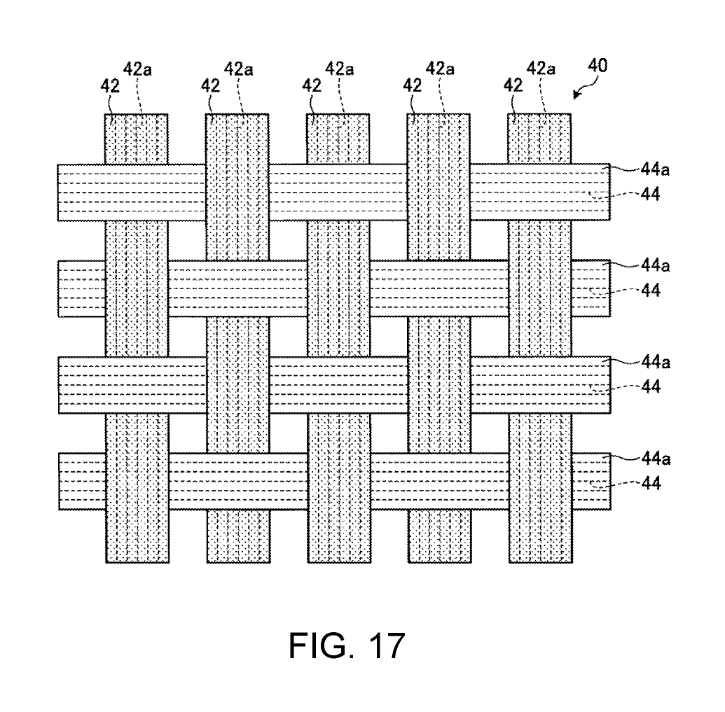

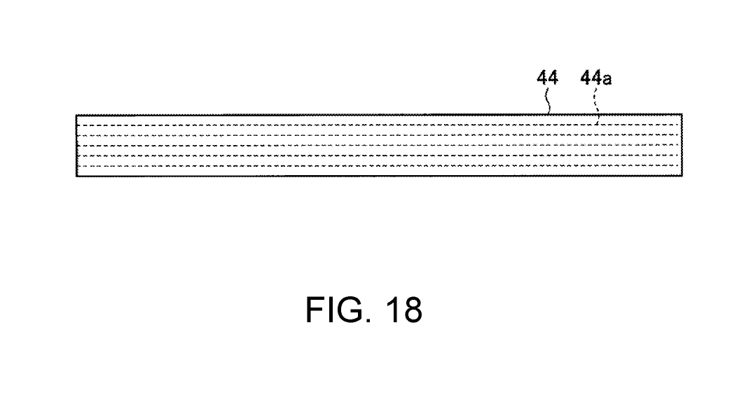

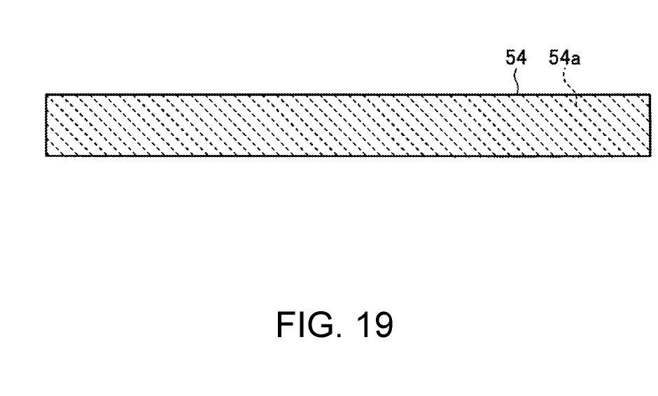

FIG. 17 is a plan view of three-dimensional shaping information 40 of a three-dimensional object processed by a three-dimensional object manufacturing apparatus according to a fourth embodiment. FIG. 18 is a schematic drawing of information of a yarn structure processed by the three-dimensional object manufacturing apparatus according to the fourth embodiment. FIG. 19 is another schematic drawing of information of a yarn structure processed by the three-dimensional object manufacturing apparatus according to the fourth embodiment. The three-dimensional object manufacturing apparatus according to the fourth embodiment is distinct from the three-dimensional object manufacturing apparatus 10 according to the first embodiment in that the three-dimensional shaping information generator 14 may optionally include pattern-related information in the three-dimensional shaping information of the three-dimensional object, and the shaping part 16 shapes the three-dimensional object and then prints a pattern thereon based on the pattern-related information included in the three-dimensional shaping information of the three-dimensional object. The three-dimensional shaping information 40 of the three-dimensional object according to the fourth embodiment is the three-dimensional shaping information 30 of the three-dimensional object according to the first embodiment further containing the pattern-related information. In the fourth embodiment hereinafter described, any structural elements similar to those of the first embodiment are illustrated with like reference sings and will not be described in detail.

When the shaping part 16 prints a pattern, the inkjet heads 24 of the shaping part 16 may eject the ultraviolet-curable inks described earlier or may eject a solvent drying ink, examples of which may include ultraviolet instantaneous drying inks and latex inks. The latex ink may be directly used on the three-dimensional object, or may be used on the ultraviolet-curable ink or ultraviolet instantaneous drying ink applied in advance to the three-dimensional object.

An example of the ultraviolet instantaneous drying ink ejected by the inkjet head 24 is an ink prepared by adding, to a solvent primarily consisting of water, 5% to 10% by mass of an ultraviolet absorbent; ultraviolet curing initiator, relative to a total ink weight, 10% to 50% by mass of a binder resin relative to the total ink weight, 2% to 10% by mass of a coloring material relative to the total ink weight, and optionally, an adjuster to adjust the viscosity or surface tension. The ultraviolet absorbent; ultraviolet curing initiator, may be selected from the examples mentioned in the description of the ultraviolet-curable ink. The binder may be a compound containing at least one selected from acrylic compounds, urethane-based compounds, epoxy-based compounds, and polyester-based compounds, or a mixture of these compounds. The coloring material may be a pigment or a dispersing dye, or both of a pigment and a dispersing dye.

Instead of the mentioned non-limiting examples, the ultraviolet instantaneous drying ink ejected by the inkjet head 24 may contain a polymerizable, exothermic compound. An example of the ultraviolet instantaneous drying ink containing a polymerizable, exothermic compound and ejected by the inkjet head 24 is an ink prepared by adding, to a solvent primarily consisting of water, 15% to 50% by mass of an ultraviolet-polymerizable compound relative to a total ink weight, 5% to 10% by mass of an ultraviolet absorbent; ultraviolet curing initiator, relative to the total ink weight, 2% to 10% by mass of a coloring material relative to the total ink weight, and optionally, an adjuster to adjust the viscosity or surface tension. Two types of ultraviolet instantaneous drying inks containing a polymerizable, exothermic compound are exemplified, which are radically polymerizable inks instantaneously dried by radial polymerization, and cationically polymerizable inks instantaneously dried by cationic polymerization. Examples of the ultraviolet-polymerizable compound usable in the radically polymerizable inks may include compounds obtainable by radical polymerization of monomers such as dipropylene acrylate, isobonyl acrylate, and methoxybutyl acrylate, and oligomers such as polyester acrylate, epoxy acrylate, and urethane acrylate. Examples of the ultraviolet absorbent; ultraviolet curing initiator, usable in the radically polymerizable inks may include acetophenone-based compounds and acyloxime-based compounds. Examples of the ultraviolet-polymerizable compound usable in the cationically polymerizable inks may include epoxy-based compounds, vinylether, and oxetane. The ultraviolet absorbent; ultraviolet curing initiator, usable in the cationically polymerizable inks may be selected from the examples mentioned in the description of the ultraviolet-curable ink. The coloring material may be selected from the examples mentioned in the description of ultraviolet instantaneous drying inks containing no polymerizable, exothermic compound. When an instantaneous drying ink containing a polymerizable, exothermic compound is used, the ink is solidified by being irradiated with ultraviolet light to thermally evaporate the solvent.

As illustrated in FIG. 17, the three-dimensional shaping information 40 of the three-dimensional object includes information of structures 42 of warp yarn vertically extending and arranged at equal intervals, and information of structures 44 of weft yarn transversely extending and arranged at equal intervals. As described referring to FIG. 2, a plane made by vertical and transverse directions in FIG. 17 extends in a direction along a plane made by X and Y axes in FIG. 1. In this embodiment, the vertical direction in FIG. 17 and the X axis in FIG. 1 coincide with each other, and the transverse direction in FIG. 17 and the Y axis in FIG. 1 coincide with each other, which is a non-limiting example of this disclosure.

As with the three-dimensional shaping information 30 of the three-dimensional object, the three-dimensional shaping information 40 of the three-dimensional object includes overlap parts, warp yarn structure visible parts, and weft yarn structure visible parts, though these parts are not illustrated in FIG. 17. The overlap parts, warp yarn structure visible parts, and weft yarn structure visible parts included in the three-dimensional shaping information 40 of the three-dimensional object are processed by the shaping part 16, as with the overlap parts 36a and 36b, warp yarn structure visible parts 36c, and weft yarn structure visible parts 36d included in the three-dimensional shaping information 30 of the three-dimensional object.

According to the three-dimensional shaping information 40 of the three-dimensional object, the three-dimensional object is formed on the upper side of a medium and includes voids, similarly to the three-dimensional shaping information 30 of the three-dimensional object, though the medium and the voids are not illustrated in FIG. 17. The voids included in the three-dimensional shaping information 40 of the three-dimensional object are processed by the shaping part 16, as with the voids 38a and 38b included in the three-dimensional shaping information 30 of the three-dimensional object.

As illustrated in FIG. 17, the structure 42 of warp yarn includes a pattern 42a. As illustrated in FIGS. 17 and 18, the structure 44 of weft yarn includes a pattern 44a. The structure 42 of warp yarn and structure 44 of weft yarn are, except that they include the patterns 42a and 44a, substantially similar to the structure 32 of warp yarn and the structure 34 of weft yarn. The structures 42 and 44, therefore, will not be described in detail. As illustrated in FIGS. 17 and 18, the patterns 42a and 44a are decoration-related information based on the yarn materials, and are specifically the patterns of fiber-like streaks constituting the yarn. Other patterns that may be included in the decoration-related information based on the yarn materials are filament patterns of natural fibers and chemical fibers.

The structure 44 of weft yarn may be replaced with a structure 54 of weft yarn illustrated in FIG. 19. As illustrated in FIG. 19, the structure 54 of weft yarn includes a pattern 54a. The structure 54 of weft yarn is, except that it includes the pattern 54a, substantially similar to the structures 34 and 44 of weft yarn. The structure 54, therefore, will not be described in detail. As illustrated in FIG. 19, the pattern 54a is decoration-related information based on the yarn twining states.

Instead of the non-limiting examples of the patterns 42a, 44a, and 54a, these patterns may be based on at least one selected from information of yarn decorations, decoration-related information based on yarn materials, and decoration-related information based on yarn twining states. Specific examples of the information of yarn decorations may include yarn color, rope mesh pattern, stipple pattern, and pattern with gradational color that vary in texture.

A three-dimensional object manufacturing method is hereinafter described. This method is an exemplified method for operating the three-dimensional object manufacturing apparatus according to the fourth embodiment. The three-dimensional object manufacturing method according to the fourth embodiment includes, as with the manufacturing method according to the first embodiment, a yarn-related information receiving step (Step S12), a weaving information receiving step (Step S14), a three-dimensional shaping information generating step (Step S16), and an object shaping step (Step S18).

Step S12 of the fourth embodiment is distinct from Step S12 of the first embodiment in that the yarn-related information receiver 18 of the input receiver 12 receives inputted information of patterns of the yarns, information of which is inputted to and received by the input receiver 12. Step S14 of the fourth embodiment are similar to Step S14 of the first embodiment. Step S16 of the fourth embodiment is distinct from Step S16 of the first embodiment in that the three-dimensional shaping information generator 14 includes the information of patterns of the yarns, information of which has been inputted and received in Step S12, in the three-dimensional shaping information 40 of the three-dimensional object. Step S18 of the fourth embodiment is distinct from Step S18 of the first embodiment in that the shaping part 16 shapes the three-dimensional object and then prints a pattern thereon based on the pattern-related information included in the three-dimensional shaping information 40 of the three-dimensional object. As a result, a three-dimensional object with a pattern printed thereon may be manufactured.

The three-dimensional object manufacturing apparatus according to the fourth embodiment and the three-dimensional object manufacturing method used by this apparatus are characterized as described so far and may accordingly provide effects similar to the three-dimensional object manufacturing apparatus 10 according to the first embodiment and the three-dimensional object manufacturing method used by the apparatus 10. According to the three-dimensional object manufacturing apparatus of the fourth embodiment and the three-dimensional object manufacturing method used by this apparatus, the three-dimensional shaping information generator 14 optionally includes the pattern-related information in the three-dimensional shaping information 40 of the three-dimensional object, and the shaping part 16 shapes the three-dimensional object and then prints a pattern thereon. This embodiment may provide three-dimensional objects including various patterns printed thereon.

According to the three-dimensional object manufacturing apparatus of the fourth embodiment and the three-dimensional object manufacturing method used by this apparatus, a pattern printed on the object is based on the information of yarn decorations, decoration-related information based on yarn materials, and decoration-related information based on yarn twining states. Therefore, a three-dimensional object having an appearance and texture of a real textile fabric may be manufactured. The three-dimensional object manufacturing apparatus of the fourth embodiment and the three-dimensional object manufacturing method used by this apparatus may deepen the quality of a textile-like texture of a three-dimensional object manufactured.

As with the modification made on the second embodiment, the three-dimensional object manufacturing apparatus of the fourth embodiment and the three-dimensional object manufacturing method used by this apparatus may be further characterized in that the three-dimensional shaping information generator 14 sets an opaque ink-usable region in the three-dimensional shaping information 40 of the three-dimensional object to apply the light blocking process, and the shaping part 16 shapes the three-dimensional object based on the three-dimensional shaping information 40 of the three-dimensional object to which the light blocking process has been applied. The three-dimensional object manufacturing apparatus of the fourth embodiment and the three-dimensional object manufacturing method used by this apparatus thus further characterized may accordingly provide effects similar to the three-dimensional object manufacturing apparatus according to the second embodiment and the three-dimensional object manufacturing method used by the apparatus 10.

As with the modification made on the third embodiment, the three-dimensional object manufacturing apparatus of the fourth embodiment and the three-dimensional object manufacturing method used by this apparatus may be further characterized in that the three-dimensional shaping information generator 14 sets the use of an opaque color ink in the three-dimensional shaping information 40 of the three-dimensional object, and the shaping part 16 shapes the three-dimensional object based on the three-dimensional shaping information 40 in which the use of an opaque color ink is set. The three-dimensional object manufacturing apparatus of the fourth embodiment and the three-dimensional object manufacturing method used by this apparatus thus further characterized may accordingly provide effects similar to the three-dimensional object manufacturing apparatus according to the third embodiment and the three-dimensional object manufacturing method used by this apparatus.

### Fifth Embodiment

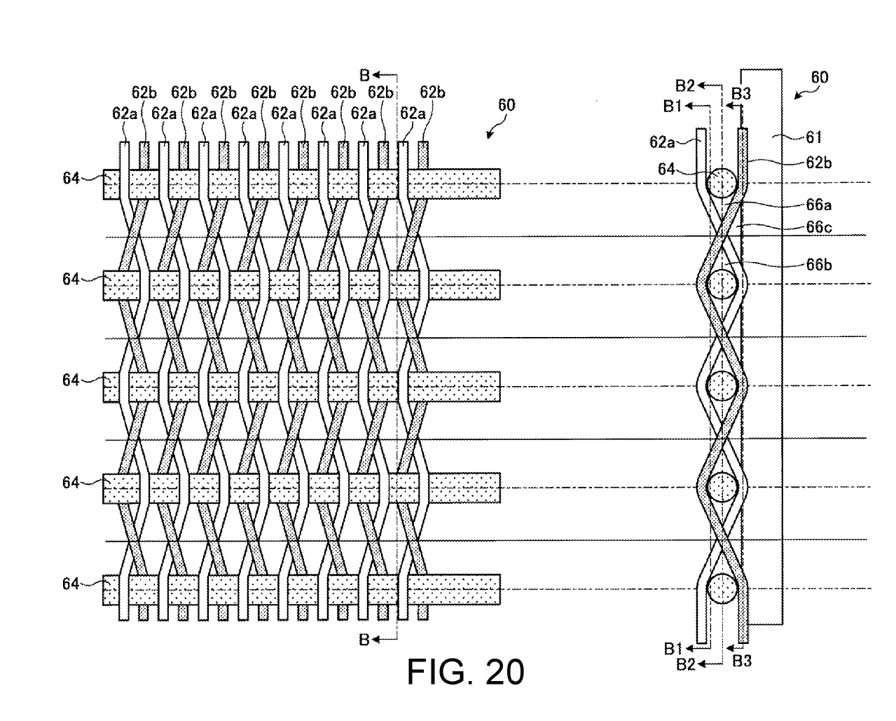

FIG. 20 is a plan view and a cross-sectional view of three-dimensional shaping information 60 of a three-dimensional object processed by a three-dimensional object manufacturing apparatus according to a fifth embodiment. FIG. 20 shows a plan view on its left side and a cross-sectional view on its right side. The plan view and the cross-sectional view are drawn, with their vertical directions being coincident with each other. The cross-sectional view on the right side of FIG. 20 is a B-B cross-sectional view of the left-side view. In the cross-sectional view on the right side of FIG. 20 are additionally drawn, from the upper side, dash-dot lines B1, B2, and B3 in the horizontal direction to describe the fifth embodiment. The dash-dot line B3 is drawn along the surface of a medium 61. The dash-dot line B2 is drawn to a height dimension along which a structure 62a of first warp yarn and a structure 62b of second warp yarn intersect with each other. The dash-dot line B1 is drawn to uppermost positions of voids 66a and 66b described later. The three-dimensional object manufacturing apparatus of the fifth embodiment is substantially similar to the three-dimensional object manufacturing apparatus of the fourth embodiment. The three-dimensional shaping information 60 of the three-dimensional object according to the fifth embodiment is the three-dimensional shaping information 30 of the three-dimensional object according to the first embodiment further characterized in that two types of structures of warp yarn are used that respectively include coloring-related information. In the fifth embodiment hereinafter described, any structural elements similar to those of the first to fourth embodiments are illustrated with like reference sings and will not be described in detail.

As illustrated in FIG. 20, the three-dimensional shaping information 60 of the three-dimensional object includes information of a three-dimensional object formed on the upper side of the medium 61. This is specifically information of structures 62a of first warp yarn and structures 62b of second warp yarn that are vertically extending and arranged at equal intervals and of structures 64 of weft yarn transversely extending and arranged at equal intervals. As described referring to FIGS. 2 and 17, a plane made by vertical and transverse directions in FIG. 20 extends in a direction along a plane made by X and Y axes in FIG. 1. In this embodiment, the vertical direction in FIG. 20 and the X axis in FIG. 1 coincide with each other, and the transverse direction in FIG. 20 and the Y axis in FIG. 1 coincide with each other, which is a non-limiting example of this disclosure.

As illustrated in FIG. 20, a respective one of the structures 62a of first warp yarn and a respective one of the structures 62b of second warp yarn are paired and interwoven, and further woven with the structures 64 of weft yarn interposed between the structures 62a and 62b. Specifically, the structures 62a of first warp yarn and the structures 62b of second warp yarn are interwoven, so that the structures 62b of second warp yarn run on the lower side of the structures 64 of weft yarn at positions at which the structures 62a of first warp yarn run on the upper side of the structures 64 of weft yarn, and the structures 62b of second warp yarn run on the upper side of the structures 64 of weft yarn at positions at which the structures 62a of first warp yarn run on the lower side of the structures 64 of weft yarn. Thus, the structures of two different warp yarns intersect with each other and run alternately on the upper side and on the lower side of the weft yarn structures at the respective positions.

The three-dimensional shaping information 60 of the three-dimensional object includes voids 66a, 66b, and 66c, as illustrated in FIG. 20. The void 66a is present adjacently to the upper structure 62a of first warp yarn, lower structure 62b of second warp yarn, and structure 64 of weft yarn. The void 66b is present adjacently to the lower structure 62a of first warp yarn, upper structure 62b of second warp yarn, and structure 64 of weft yarn. The void 66c is present adjacently to the medium 61, lower structure 62a of first warp yarn, and lower structure 62b of second warp yarn. The voids 66a, 66b, and 66c are present in the transverse direction, i.e., along a direction in which the structures 64 of weft yarn are extending.

The voids 66a, 66b, and 66c included in the three-dimensional shaping information 60 of the three-dimensional object are processed by the shaping part 16, as with the voids 38a and 38b included in the three-dimensional shaping information 30 of the three-dimensional object and the voids included in the three-dimensional shaping information 40 of the three-dimensional object. The shaping part 16 forms the voids on the lower side of the dash-dot line B1 alone, without shaping any voids on the upper side of the dash-dot line B 1. Thus, the structures on the upper side alone are shaped like a real textile fabric.

The structure 62a of first warp yarn, structure 62b of second warp yarn, and structure 64 of weft yarn respectively have different colors. The structure 62a of first warp yarn, structure 62b of second warp yarn, and structure 64 of weft yarn may be characterized otherwise. As described in the fourth embodiment, these structures may be based on other information, for example, at least one selected from information of yarn decorations, decoration-related information based on yarn materials, and decoration-related information based on yarn twining states.

For large-area color printing, the shaping part 16, when shaping the lower part of an object to be colored, may prompt the inkjet heads 24 to eject the ultraviolet-curable inks having substantially the same colors as used in the color printing. The three-dimensional object thus obtained may be colored as desired. For large-area color printing, the shaping part 16 may use inks of desired colors prepared beforehand in advance. This may reduce the risk of color irregularity that depends on printing dates and positions.

A three-dimensional object manufacturing method is hereinafter described. This method is an exemplified method for operating the three-dimensional object manufacturing apparatus according to the fifth embodiment. The three-dimensional object manufacturing method of the fifth embodiment includes, as with the manufacturing method of the fourth embodiment, a yarn-related information receiving step (Step S12), a weaving information receiving step (Step S14), a three-dimensional shaping information generating step (Step S16), and an object shaping step (Step S18).

Step S12 of the fifth embodiment is distinct from Step S12 of the fourth embodiment in that the yarn-related information receiver 18 of the input receiver 12 receives inputted information of three different types of yarns. Steps S14, S16, and S18 of the fifth embodiment are similar to Steps S14, S16, and S18 of the fourth embodiment. As a result, a three-dimensional object rich in coloration may be manufactured.

The three-dimensional object manufacturing apparatus of the fifth embodiment and the three-dimensional object manufacturing method used by this apparatus are characterized as described so far and may accordingly provide effects similar to the three-dimensional object manufacturing apparatus 10 of the first embodiment and the three-dimensional object manufacturing method used by this apparatus and the three-dimensional object manufacturing apparatus of the fourth embodiment and the three-dimensional object manufacturing method used by this apparatus.

As with the modification made on the second embodiment, the three-dimensional object manufacturing apparatus of the fifth embodiment and the three-dimensional object manufacturing method used by this apparatus may be further characterized in that the three-dimensional shaping information generator 14 sets an opaque ink-usable region in the three-dimensional shaping information 60 of the three-dimensional object to apply the light blocking process, and the shaping part 16 shapes the three-dimensional object based on the three-dimensional shaping information 60 of the three-dimensional object to which the light blocking process has been applied. The three-dimensional object manufacturing apparatus of the fifth embodiment and the three-dimensional object manufacturing method used by this apparatus thus characterized may accordingly provide effects similar to the three-dimensional object manufacturing apparatus of the second embodiment and the three-dimensional object manufacturing method used by this apparatus.

As with the modification made on the third embodiment, the three-dimensional object manufacturing apparatus of the fifth embodiment and the three-dimensional object manufacturing method used by this apparatus may be further characterized in that the three-dimensional shaping information generator 14 sets the use of an opaque color ink in the three-dimensional shaping information 60 of the three-dimensional object, and the shaping part 16 shapes the three-dimensional object based on the three-dimensional shaping information 60 in which the use of an opaque color ink is set. The three-dimensional object manufacturing apparatus of the fifth embodiment and the three-dimensional object manufacturing method used by this apparatus thus characterized may accordingly provide effects similar to the three-dimensional object manufacturing apparatus of the third embodiment and the three-dimensional object manufacturing method used by this apparatus.

### Sixth Embodiment

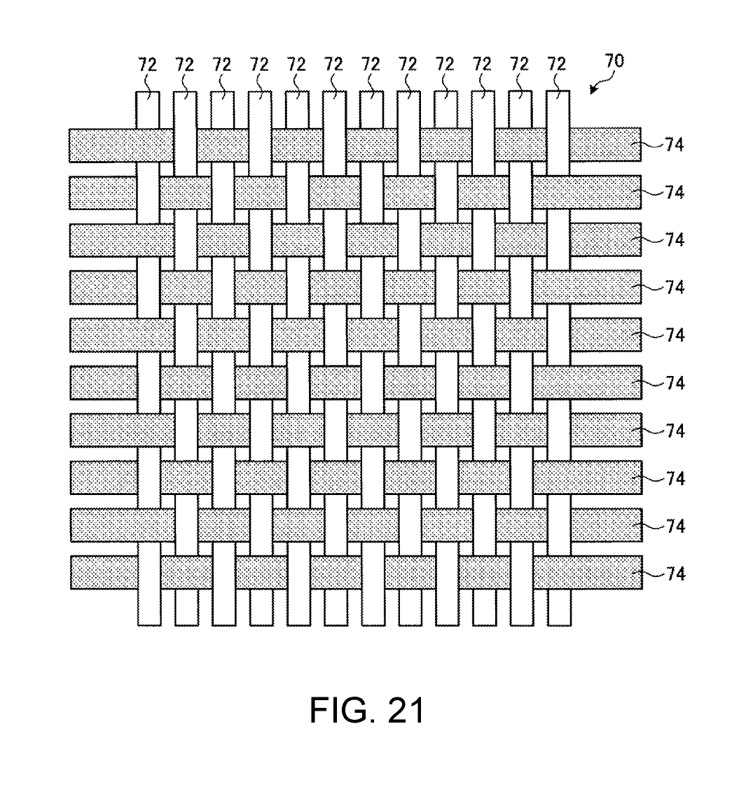

FIG. 21 is a plan view of three-dimensional shaping information 70 of a three-dimensional object processed by a three-dimensional object manufacturing apparatus according to a sixth embodiment. A three-dimensional object manufacturing apparatus of the sixth embodiment is substantially the same as the three-dimensional object manufacturing apparatuses of the fourth and fifth embodiments. The three-dimensional shaping information 70 of the three-dimensional object according to the sixth embodiment is the three-dimensional shaping information 40 of the three-dimensional object according to the fourth embodiment further characterized in that the yarn structures respectively include coloring-related information and pattern-related information. In the sixth embodiment hereinafter described, any structural elements similar to those of the first to fifth embodiments are illustrated with like reference sings and will not be described in detail.

As illustrated in FIG. 21, the three-dimensional shaping information 70 of the three-dimensional object includes information of structures 72 of warp yarn vertically extending and arranged at equal intervals, and information of structures 74 of weft yarn transversely extending and arranged at equal intervals. As described referring to FIGS. 2, 17, and 20, a plane made by vertical and transverse directions in FIG. 21 extends in a direction along a plane made by X and Y axes in FIG. 1. In this embodiment, the vertical direction in FIG. 21 and the X axis in FIG. 1 coincide with each other, and the transverse direction in FIG. 21 and the Y axis in FIG. 1 coincide with each other, which is a non-limiting example of this disclosure.

As with the three-dimensional shaping information 30 of the three-dimensional object, the three-dimensional shaping information 70 of the three-dimensional object includes overlap parts, warp yarn structure visible parts, and weft yarn structure visible parts, though these parts are not illustrated in FIG. 21. The overlap parts, warp yarn structure visible parts, and weft yarn structure visible parts included in the three-dimensional shaping information 70 of the three-dimensional object are processed by the shaping part 16, as with the overlap parts 36a and 36b, warp yarn structure visible parts 36c, and weft yarn structure visible parts 36d included in the three-dimensional shaping information 30 of the three-dimensional object.

According to the three-dimensional shaping information 70 of the three-dimensional object, the three-dimensional object is formed on the upper side of a medium and includes voids, similarly to the three-dimensional shaping information 30 of the three-dimensional object, though the medium and the voids are not illustrated in FIG. 21. The voids included in the three-dimensional shaping information 70 of the three-dimensional object are processed by the shaping part 16, similarly to the voids 38a and 38b included in the three-dimensional shaping information 30 of the three-dimensional object.

The structure 72 of warp yarn and the structure 74 of weft yarn respectively include pieces of information of different patterns. Specifically, the structures 72 of warp yarn are colored, while the structures 74 of weft yarn are decorated with colored patterns. The structure 72 of warp yarn and the structure 74 of weft yarn may be characterized otherwise. As described in the fourth and fifth embodiments, these structures may be based on other information, for example, at least one selected from information of yarn decorations, decoration-related information based on yarn materials, and decoration-related information based on yarn twining states.

The three-dimensional object manufacturing method, which is an exemplified method of operation the three-dimensional object manufacturing apparatus of the sixth embodiment, is similar to the three-dimensional object manufacturing method of the fourth embodiment, and is thus not described in detail.

The three-dimensional object manufacturing apparatus of the sixth embodiment and the three-dimensional object manufacturing method used by this apparatus are characterized as described so far and may accordingly provide effects similar to the three-dimensional object manufacturing apparatus 10 of the first embodiment and the three-dimensional object manufacturing method used by this apparatus and the three-dimensional object manufacturing apparatus of the fourth embodiment and the three-dimensional object manufacturing method used by this apparatus, similarly to the three-dimensional object manufacturing apparatus of the fifth embodiment and the three-dimensional object manufacturing method used by this apparatus.

As with the modification made on the second embodiment, the three-dimensional object manufacturing apparatus of the sixth embodiment and the three-dimensional object manufacturing method used by this apparatus may be further characterized in that the three-dimensional shaping information generator 14 sets an opaque ink-usable region in the three-dimensional shaping information 70 of the three-dimensional object to apply the light blocking process, and the shaping part 16 shapes the three-dimensional object based on the three-dimensional shaping information 70 of the three-dimensional object to which the light blocking process has been applied. The three-dimensional object manufacturing apparatus of the sixth embodiment and the three-dimensional object manufacturing method used by this apparatus thus characterized may accordingly provide effects similar to the three-dimensional object manufacturing apparatus of the second embodiment and the three-dimensional object manufacturing method used by this apparatus.

As with the modification made on the third embodiment, the three-dimensional object manufacturing apparatus of the sixth embodiment and the three-dimensional object manufacturing method used by this apparatus may be further characterized in that the three-dimensional shaping information generator 14 sets the use of an opaque color ink in the three-dimensional shaping information 70 of the three-dimensional object, and the shaping part 16 shapes the three-dimensional object based on the three-dimensional shaping information 70 in which the use of an opaque color ink is set. The three-dimensional object manufacturing apparatus of the sixth embodiment and the three-dimensional object manufacturing method used by this apparatus thus characterized may accordingly provide effects similar to the three-dimensional object manufacturing apparatus of the third embodiment and the three-dimensional object manufacturing method used by this apparatus.

### Seventh Embodiment

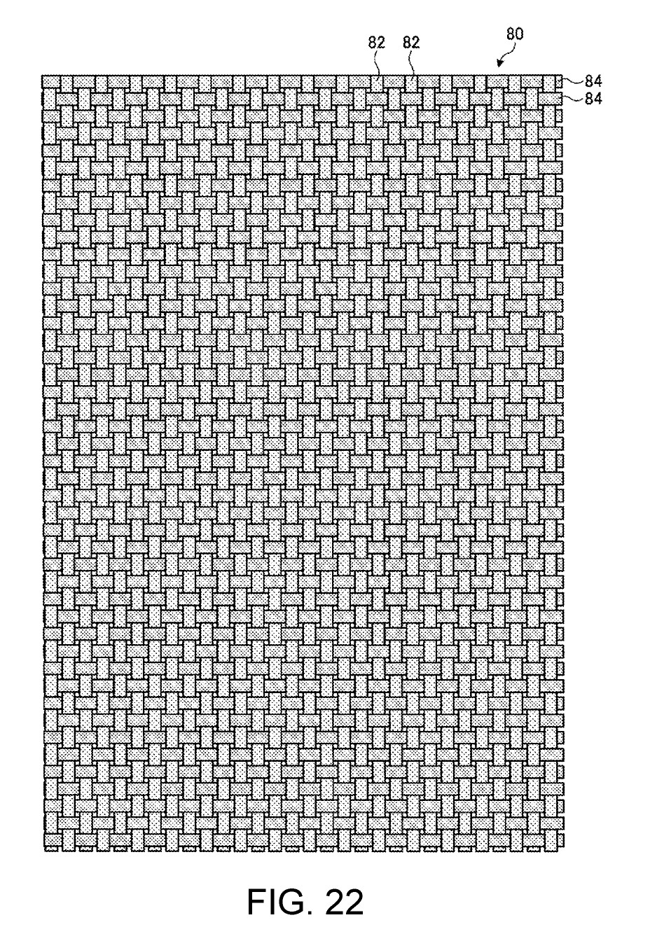

FIG. 22 is a plan view of three-dimensional shaping information 80 of a three-dimensional object processed by a three-dimensional object manufacturing apparatus according to a seventh embodiment. The three-dimensional object manufacturing apparatus of the seventh embodiment is distinct from the three-dimensional object manufacturing apparatuses of the fourth, fifth, and sixth embodiments in that the input receiver 12 receives inputted information of textile decoration as the pattern-related information, the three-dimensional shaping information generator 14 includes the information of textile decoration in the three-dimensional shaping information 80 of the three-dimensional object, and the shaping part 16 shapes the three-dimensional object and then prints a textile pattern thereon based on the information of textile decoration included in the three-dimensional shaping information 80 of the three-dimensional object. The three-dimensional shaping information 80 of the three-dimensional object according to the seventh embodiment is the three-dimensional shaping information 40 of the three-dimensional object according to the fourth embodiment further containing the decoration-related information of a yarn-interwoven textile fabric. In the seventh embodiment hereinafter described, any structural elements similar to those of the first to sixth embodiments are illustrated with like reference sings and will not be described in detail.

As illustrated in FIG. 22, the three-dimensional shaping information 80 of the three-dimensional object includes information of structures 82 of warp yarn vertically extending and arranged at equal intervals, and information of structures 84 of weft yarn transversely extending and arranged at equal intervals. As described referring to FIGS. 2, 17, 20, and 21, a plane made by vertical and transverse directions in FIG. 22 extends in a direction along a plane made by X and Y axes in FIG. 1. In this embodiment, the vertical direction in FIG. 22 and the X axis in FIG. 1 coincide with each other, and the transverse direction in FIG. 22 and the Y axis in FIG. 1 coincide with each other, which is a non-limiting example of this disclosure.

The three-dimensional shaping information 80 of the three-dimensional object includes, as pattern-related information, decoration-related information of the whole yarn-interwoven textile. This information of textile decoration is processed in a manner different to the information of the structures 82 of warp yarn and the structures 84 of weft yarn. Examples of the information of textile decoration may include information of textile embroidery, information of two-dimensional images such as paintings, and information of colored ground patterns.

As with the three-dimensional shaping information 30 of the three-dimensional object, the three-dimensional shaping information 80 of the three-dimensional object includes overlap parts, warp yarn structure visible parts, and weft yarn structure visible parts, though these parts are not illustrated in FIG. 22. The overlap parts, warp yarn structure visible parts, and weft yarn structure visible parts included in the three-dimensional shaping information 80 of the three-dimensional object are processed by the shaping part 16, as with the overlap parts 36a and 36b, warp yarn structure visible parts 36c, and weft yarn structure visible parts 36d included in the three-dimensional shaping information 30 of the three-dimensional object.

According to the three-dimensional shaping information 80 of the three-dimensional object, the three-dimensional object is formed on the upper side of a medium and includes voids, similarly to the three-dimensional shaping information 30 of the three-dimensional object, though the medium and the voids are not illustrated in FIG. 22. The voids included in the three-dimensional shaping information 80 of the three-dimensional object are processed by the shaping part 16, similarly to the voids 38a and 38b included in the three-dimensional shaping information 30 of the three-dimensional object.

A three-dimensional object manufacturing method is hereinafter described. This method is an exemplified method for operating the three-dimensional object manufacturing apparatus according to the seventh embodiment. The three-dimensional object manufacturing method of the seventh embodiment includes, as with the manufacturing methods of the first to sixth embodiments, a yarn-related information receiving step (Step S12), a weaving information receiving step (Step S14), a three-dimensional shaping information generating step (Step S16), and an object shaping step (Step S18).

Steps S12 and S14 of the seventh embodiment are similar to Steps S12 and S14 of the first embodiment. In the seventh embodiment, the input receiver 12 further receives inputted decoration-related information of a yarn-interwoven textile fabric.

Step S16 of the seventh embodiment is distinct from Step S16 of the first embodiment in that the three-dimensional shaping information generator 14 includes the received information of textile decoration in the three-dimensional shaping information 80 of the three-dimensional object.

Step S18 of the seventh embodiment is distinct from Step S18 of the first embodiment in that the shaping part 16 shapes the three-dimensional object and then prints a decorative pattern thereon based on the information of textile decoration included in the three-dimensional shaping information 80 of the three-dimensional object. Thus, a three-dimensional object with a decorative pattern is manufactured.

The three-dimensional object manufacturing apparatus according to the seventh embodiment and the three-dimensional object manufacturing method used by this apparatus are characterized as described so far and may accordingly provide effects similar to the three-dimensional object manufacturing apparatus 10 according to the first embodiment and the three-dimensional object manufacturing method used by the apparatus 10. Additionally, according to the three-dimensional object manufacturing apparatus of the seventh embodiment and the three-dimensional object manufacturing method used by this apparatus, the three-dimensional shaping information generator 14 includes the information of textile decoration in the three-dimensional shaping information 80 of the three-dimensional object, and the shaping part 16 shapes the three-dimensional object and then prints a decorative pattern thereon. This embodiment may provide three-dimensional objects that differ in various aspects including their patterns printed thereon.

According to the three-dimensional object manufacturing apparatus of the seventh embodiment and the three-dimensional object manufacturing method used by this apparatus, a pattern printed on the object is based on the information of textile decoration. Therefore, a three-dimensional object having an appearance and texture of a real textile fabric, as if a decorative pattern-printed fabric, may be manufactured. The three-dimensional object manufacturing apparatus of the seventh embodiment and the three-dimensional object manufacturing method used by this apparatus may deepen the quality of a textile-like texture of a three-dimensional object manufactured.

As with the modification made on the second embodiment, the three-dimensional object manufacturing apparatus of the seventh embodiment and the three-dimensional object manufacturing method used by this apparatus may be further characterized in that the three-dimensional shaping information generator 14 sets an opaque ink-usable region the three-dimensional shaping information 80 of the three-dimensional object to apply the light blocking process, and the shaping part 16 shapes the three-dimensional object based on the three-dimensional shaping information 80 of the three-dimensional object to which the light blocking process has been applied. The three-dimensional object manufacturing apparatus of the seventh embodiment and the three-dimensional object manufacturing method used by this apparatus thus characterized may accordingly provide effects similar to the three-dimensional object manufacturing apparatus of the second embodiment and the three-dimensional object manufacturing method used by this apparatus.

As with the third embodiment, the three-dimensional object manufacturing apparatus of the seventh embodiment and the three-dimensional object manufacturing method used by this apparatus may be further characterized in that the three-dimensional shaping information generator 14 sets the use of an opaque color ink in the three-dimensional shaping information 80 of the three-dimensional object, and the shaping part 16 shapes the three-dimensional object based on the three-dimensional shaping information 80 in which the use of an opaque color ink is set. The three-dimensional object manufacturing apparatus of the seventh embodiment and the three-dimensional object manufacturing method used by this apparatus thus characterized may accordingly provide effects similar to the three-dimensional object manufacturing apparatus of the third embodiment and the three-dimensional object manufacturing method used by this apparatus.

### Eighth Embodiment

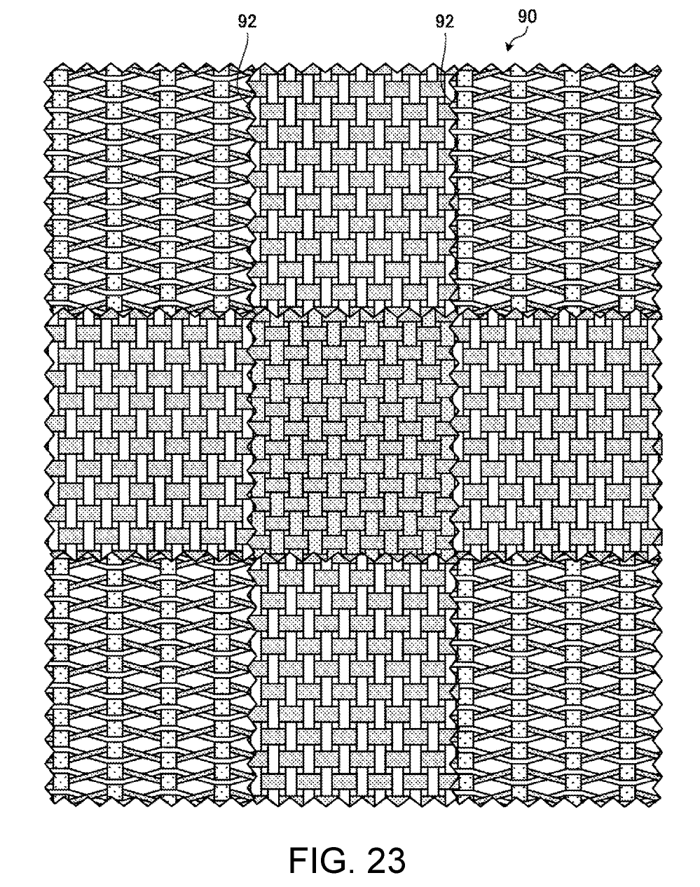

FIG. 23 is a plan view of three-dimensional shaping information 90 of a composite three-dimensional object processed by a three-dimensional object manufacturing apparatus according to an eighth embodiment. The three-dimensional object manufacturing apparatus of the eighth embodiment is distinct from the three-dimensional object manufacturing apparatuses of the fourth, fifth, sixth, and seventh embodiments in that the input receiver 12, three-dimensional shaping information generator 14, and shaping part 16 are reconfigured as described later. As illustrated in FIG. 23, the three-dimensional shaping information 90 of a composite three-dimensional object according to the eighth embodiment is a combination of the three-dimensional shaping information 60 of the three-dimensional object according to the fifth embodiment, three-dimensional shaping information 70 of the three-dimensional object according to the sixth embodiment, and three-dimensional shaping information 80 of the three-dimensional object according to the seventh embodiment. In the eighth embodiment hereinafter described, any structural elements similar to those of the first to seventh embodiments are illustrated with like reference sings and will not be described in detail.

In contrast to the input receiver 12 in the three-dimensional object manufacturing apparatus of the fourth, fifth, sixth, or seventh embodiment, the input receiver 12 of the eighth embodiment is further configured such that the yarn-related information receiver 18 of the input receiver 12 is reconfigured to receive inputted information of a plurality of combinations of yarns, and the weaving method receiver 19 of the input receiver 12 is reconfigured to receive inputted information of weaving methods for the combinations of yarns. The input receiver 12 of the eighth embodiment is then reconfigured to receive inputted information of how to combine textile-like structures formed by using the combinations of yarns. The information of how to combine textile-like structures specifically includes, for example, information of positions of and the number of textile-like structures arranged at the positions, and information of how to interconnect the textile-like structures.

In contrast to the three-dimensional shaping information generators 14 in the three-dimensional object manufacturing apparatus of the fourth, fifth, sixth, or seventh embodiment, the three-dimensional shaping information generator 14 of the eighth embodiment is further configured to generate a plurality of pieces of three-dimensional shaping information based on information of a plurality of combinations of yarns and information of weaving methods for the combinations of yarns inputted to and received by the input receiver 12. The three-dimensional shaping information generator 14 of the eighth embodiment is further configured to generate three-dimensional shaping information of a composite three-dimensional object by combining pieces of three-dimensional shaping information of the textile-like structures based on the information of how to combine the textile-like structures inputted to and received by the input receiver 12.

In contrast to the shaping part 16 in the three-dimensional object manufacturing apparatus of the fourth, fifth, sixth, or seventh embodiment, the shaping part 16 of the eighth embodiment shapes a composite three-dimensional object based on the three-dimensional shaping information of the composite three-dimensional object generated by the three-dimensional shaping information generator 14.

As illustrated in FIG. 23, the three-dimensional shaping information 90 of the composite three-dimensional object according to the eighth embodiment is a combination of three pieces of three-dimensional shaping information. The three-dimensional shaping information 90 of the composite three-dimensional object according to the eighth embodiment includes information indicating that four pieces of the three-dimensional shaping information 60 of the three-dimensional object according to the fifth embodiment are located at four corner positions. The three-dimensional shaping information 90 of the composite three-dimensional object according to the eighth embodiment includes information indicating that four pieces of the three-dimensional shaping information 70 of the three-dimensional object according to the sixth embodiment are located at four positions between two opposing pieces of the three-dimensional shaping information 60. The three-dimensional shaping information 90 of the composite three-dimensional object according to the eighth embodiment includes information indicating that one piece of the three-dimensional shaping information 80 of the three-dimensional object according to the seventh embodiment is located at the center position. The three-dimensional shaping information 90 of the composite three-dimensional object according to the eighth embodiment includes information of yarn structures 92. The yarn structure 92 has a lightning bolt shape, i.e., a zigzag shape and interconnects pieces of three-dimensional shaping information of the respective structures.

As with the three-dimensional shaping information 30 of the three-dimensional object, the three-dimensional shaping information 90 of the composite three-dimensional object includes overlap parts, warp yarn structure visible parts, and weft yarn structure visible parts, though these parts are not illustrated in FIG. 23. The overlap parts, warp yarn structure visible parts, and weft yarn structure visible parts included in the three-dimensional shaping information 90 of the composite three-dimensional object are processed by the shaping part 16, similarly to the overlap parts 36a and 36b, warp yarn structure visible parts 36c, and weft yarn structure visible parts 36d included in the three-dimensional shaping information 30 of the three-dimensional object.

According to the three-dimensional shaping information 90 of the composite three-dimensional object, the three-dimensional object is formed on the upper side of a medium and includes voids, similarly to the three-dimensional shaping information 30 of the three-dimensional object, though the medium and the voids are not illustrated in FIG. 23. The voids included in the three-dimensional shaping information 90 of the composite three-dimensional object are processed by the shaping part 16, similarly to the voids 38a and 38b included in the three-dimensional shaping information 30 of the three-dimensional object.

A three-dimensional object manufacturing method is hereinafter described. This method is an exemplified method for operating the three-dimensional object manufacturing apparatus according to the eighth embodiment. The three-dimensional object manufacturing method of the eighth embodiment includes, as with the manufacturing methods of the first to seventh embodiments, a yarn-related information receiving step (Step S12), a weaving information receiving step (Step S14), a three-dimensional shaping information generating step (Step S16), and an object shaping step (Step S18).

Steps S12 and S14 of the eighth embodiment are distinct from Steps S12 and S14 of the first embodiment in that the yarn-related information receiver 18 of the input receiver 12 receives inputted information of a plurality of combinations of yarns, and the weaving method receiver 19 of the input receiver 12 receives inputted information of weaving methods for the combination of yarns. The input receiver 12 of the eighth embodiment receives inputted information of how to combine textile-like structures formed by using the combinations of yarns. Specifically, in a case where the composite three-dimensional object is formed based on the three-dimensional shaping information 90 of the composite three-dimensional object, in Steps S12 and S14, the input receiver 12 receives inputted information that allows the following pieces of information to be generated; three-dimensional shaping information 60 of the three-dimensional object, three-dimensional shaping information 70 of the three-dimensional object, three-dimensional shaping information 80 of the three-dimensional object, information of positions of and the number of the three-dimensional shaping information of textile-like structures arranged at the positions, and information of the yarn structures 92.

Steps S16 of the eighth embodiment is distinct from Step S16 of the first embodiment in that the three-dimensional shaping information generator 14 generates a plurality of pieces of three-dimensional shaping information of the three-dimensional object based on information of the combinations of yarns and information of yarn weaving methods inputted to and received by the input receiver 12. The three-dimensional shaping information generator 14 of the eighth embodiment generates the three-dimensional shaping information 90 of a composite three-dimensional object by combining the pieces of three-dimensional shaping information of the textile-like structures based on information of how to combine the textile-like structures inputted to and received by the input receiver 12. Specifically, in a case where the composite three-dimensional object is formed based on the three-dimensional shaping information 90 of the composite three-dimensional object, the three-dimensional shaping information generator 14 generates the three-dimensional shaping information 60 of the three-dimensional object, three-dimensional shaping information 70 of the three-dimensional object, and three-dimensional shaping information 80 of the three-dimensional object to be included in the three-dimensional shaping information 90 of the composite three-dimensional object, and then generates the three-dimensional shaping information 90 of the composite three-dimensional object.

In Step S18 of the eighth embodiment, the shaping part 16, similarly to Step S18 of the first embodiment, shapes the composite three-dimensional object based on the three-dimensional shaping information 90 of the composite-three-dimensional object generated by the three-dimensional shaping information generator 14. As a result, a composite three-dimensional object in which a plurality of texture-like structures are combined may be successfully manufactured.

The three-dimensional object manufacturing apparatus according to the eighth embodiment and the three-dimensional object manufacturing method used by this apparatus are characterized as described so far and may accordingly provide effects similar to the three-dimensional object manufacturing apparatus 10 according to the first embodiment and the three-dimensional object manufacturing method used by the apparatus 10. Additionally, in the three-dimensional object manufacturing apparatus according to the eighth embodiment and the three-dimensional object manufacturing method used by this apparatus, the yarn-related information receiver 18 of the input receiver 12 receives inputted information of the combinations of yarns, and the weaving method receiver 19 of the input receiver 12 receives inputted information of weaving methods for the combination of yarns. The input receiver 12 further receives inputted information of how to combine the textile-like structures formed by the combinations of yarns. In the three-dimensional object manufacturing apparatus according to the eighth embodiment and the three-dimensional object manufacturing method used by this apparatus, the three-dimensional shaping information generator 14 combines the different pieces of three-dimensional shaping information to generate the three-dimensional shaping information 90 of the composite three-dimensional object, and the shaping part 16 shapes the composite three-dimensional object based on the generated three-dimensional shaping information 90 of the composite three-dimensional object. The three-dimensional object manufacturing apparatus of the eighth embodiment and the three-dimensional object manufacturing method used by this apparatus may successfully manufacture a composite three-dimensional object in which a plurality of textile-like textures are combined.

The three-dimensional object manufacturing apparatus of the eighth embodiment and the three-dimensional object manufacturing method used by this apparatus may manufacture, for example, a three-dimensional object presenting an appearance and texture like a patchwork composed of pieces of textiles. The three-dimensional object manufacturing apparatus of the eighth embodiment and the three-dimensional object manufacturing method used by this apparatus may combine the textile-like structures using the darkened yarn structures 92, so that a three-dimensional object obtained may resemble a real patchwork in which interconnected parts stand out. The three-dimensional object manufacturing apparatus of the eighth embodiment and the three-dimensional object manufacturing method used by this apparatus may combine the textile-like structures using the yarn structures 92 formed in the same color as the structures to be combined, so that a three-dimensional object obtained may resemble a real patchwork with less noticeable interconnected parts. The three-dimensional object manufacturing apparatus of the eighth embodiment and the three-dimensional object manufacturing method used by this apparatus may be used to print the decoration of a favorite painting on a textile-like structure at the center and decorate the other textile-like structures in a manner that they evoke the art of the painting at the center. A three-dimensional object thus obtained may appear to be an authentic textile-made artistic piece that allows a favorite painting to attract attention.

As with the modification made on the second embodiment, the three-dimensional object manufacturing apparatus of the eighth embodiment and the three-dimensional object manufacturing method used by this apparatus may be further characterized in that the three-dimensional shaping information generator 14 sets an opaque ink-usable region in the three-dimensional shaping information 90 of the composite three-dimensional object to apply the light blocking process, and the shaping part 16 shapes the composite three-dimensional object based on the three-dimensional shaping information 90 of the composite three-dimensional object to which the light blocking process has been applied. The three-dimensional object manufacturing apparatus of the eighth embodiment and the three-dimensional object manufacturing method used by this apparatus thus characterized may accordingly provide effects similar to the three-dimensional object manufacturing apparatus of the second embodiment and the three-dimensional object manufacturing method used by this apparatus.

As with the modification made on the third embodiment, the three-dimensional object manufacturing apparatus of the eighth embodiment and the three-dimensional object manufacturing method used by this apparatus may be further characterized in that the three-dimensional shaping information generator 14 sets the use of an opaque color ink in the three-dimensional shaping information 90 of the composite three-dimensional object, and the shaping part 16 shapes the composite three-dimensional object based on the three-dimensional shaping information 90 of the composite three-dimensional object in which the use of an opaque color ink is set. The three-dimensional object manufacturing apparatus of the eighth embodiment and the three-dimensional object manufacturing method used by this apparatus thus characterized may accordingly provide effects similar to the three-dimensional object manufacturing apparatus of the third embodiment and the three-dimensional object manufacturing method used by this apparatus.

### Ninth Embodiment

A three-dimensional object manufacturing apparatus according to a ninth embodiment is distinct from the three-dimensional object manufacturing apparatuses according to the first to eighth embodiments in that the three-dimensional shaping information generator includes image-related information in the three-dimensional shaping information, and a printing part is further provided that prints an image on a surface opposite to the working plane 21a, i.e., an outer surface, of the three-dimensional object or composite three-dimensional object based on the three-dimensional shaping information including the image-related information. In the ninth embodiment hereinafter described, any structural elements similar to those of the first to eighth embodiments are illustrated with like reference sings and will not be described in detail.

The printing part prints an image on a surface opposite to the working plane 21a, i.e., an outer surface, of the three-dimensional object or composite three-dimensional object based on the three-dimensional shaping information including the image-related information. The printing part ejects inks onto the three-dimensional object formed on the working plane 21a and dries the ejected inks to form an image on the outer surface of the three-dimensional object or composite three-dimensional object. The printing part is configured similarly to the shaping part 16 and is allowed to move in reciprocating motion relative to the working plane 21a in the main and sub scanning directions. The printing part is electrically coupled to the controller 28 and is controlled to operate by the controller 28.

The printing part may eject ultraviolet-curable inks and irradiate the ejected inks with ultraviolet light to dry the inks. The printing part may eject the same or substantially the same type of ultraviolet-curable inks as used by the inkjet heads 24 and irradiate the ejected inks with the same or substantially the same type of ultraviolet light as radiated by the ultraviolet irradiator 25. The printing part may be integral with the shaping part 16.

A three-dimensional object manufacturing method is hereinafter described. This method is an exemplified method for operating the three-dimensional object manufacturing apparatus according to the ninth embodiment. The three-dimensional object manufacturing method of the ninth embodiment includes a yarn-related information receiving step (Step S12), a weaving information receiving step (Step S14), a three-dimensional shaping information generating step (Step S16), and an object shaping step (Step S18), as with the manufacturing methods of the first to eighth embodiments, and further includes a printing step.

Steps S12 to S18 of the ninth embodiment are similar to Steps S12 to S18 of the first to eighth embodiments. Subsequent to Step S18, the printing part performs a printing step of printing an image on the outer surface of the three-dimensional object or composite three-dimensional object shaped by the shaping part 16 in Step S18. As a result, a three-dimensional object or a composite three-dimensional object with an image printed on its outer surface may be manufactured.

The three-dimensional object manufacturing apparatus according to the ninth embodiment and the three-dimensional object manufacturing method used by this apparatus are characterized as described so far and may accordingly provide effects similar to the three-dimensional object manufacturing apparatus 10 according to the first embodiment and the three-dimensional object manufacturing method used by the apparatus 10. The three-dimensional object manufacturing apparatus according to the ninth embodiment and the three-dimensional object manufacturing method used by this apparatus are further characterized in that the printing part prints an image on the outer surface of the three-dimensional object or composite three-dimensional object shaped by the shaping part 16. The three-dimensional object manufacturing apparatus of the ninth embodiment and the three-dimensional object manufacturing method used by this apparatus may successfully manufacture a three-dimensional object or a composite three-dimensional object with an image printed on its outer surface. The three-dimensional object manufacturing apparatus of the ninth embodiment and the three-dimensional object manufacturing method used by this apparatus further including image printing means may obtain a three-dimensional object or a composite three-dimensional object more expressive and appealing.

What is claimed is:

1. A manufacturing apparatus for a three-dimensional object, comprising:
a yarn-related information receiver that receives information inputted of a yarn;
a weaving method receiver that receives information inputted of a weaving method for the yarn;
a three-dimensional shaping information generator that generates three-dimensional shaping information of the three-dimensional object based on the information of the yarn and the information of the weaving method for the yarn; and
a shaping part that shapes the three-dimensional object on a working plane by ejecting an object forming material onto the working plane and curing the object forming material ejected based on the three-dimensional shaping information.

2. The manufacturing apparatus according to claim 1,
wherein the three-dimensional shaping information includes information of a shape in cross section of a structure of the yarn,
the shape in cross section of the structure of the yarn is rounded, and
the shaping part shapes the three-dimensional object so that the shape in cross section of the structure of the yarn is rounded.

3. The manufacturing apparatus according to claim 1,
wherein the three-dimensional shaping information includes information of an overlap between structures of a plurality of the yarns, and
the shaping part starts with shaping a structure of one of the plurality of the yarns on a side closer to the working plane than a structure of a main yarn among the plurality of the yarns, then proceeds to shaping the structure of the main yarn during a scan performed along a direction in which the structure of the main yarn extends, and finally shapes a structure of one of the plurality of the yarns on a side opposite to the working plane relative to the structure of the main yarn.

4. The manufacturing apparatus according to claim 1,
wherein the three-dimensional shaping information generator generates a piece of three-dimensional shaping information per minimum unit based on the information of the yarn and the information of the weaving method for the yarn and repeatedly processes the piece of three-dimensional shaping information per minimum unit to generate the three-dimensional shaping information of the three-dimensional object.

5. The manufacturing apparatus according to claim 1,
wherein the three-dimensional shaping information generator sets an opaque ink-usable region in the three-dimensional shaping information of the three-dimensional object, and
the shaping part shapes the three-dimensional object based on the three-dimensional shaping information of the three-dimensional object in which the opaque ink-usable region is set.

6. The manufacturing apparatus according to claim 1,
wherein the three-dimensional shaping information generator sets use of an opaque ink in the three-dimensional shaping information of the three-dimensional object, and
the shaping part shapes the three-dimensional object using the opaque ink.

7. The manufacturing apparatus according to claim 6,
wherein the opaque ink comprises a white pigment, and
the white pigment includes any one selected from a hollow white pigment, micro-encapsulated titanium oxide, micro-encapsulated zinc oxide, and nanoparticles having an average particle size less than or equal to 300 nm.

8. The manufacturing apparatus according to claim 1,
wherein the three-dimensional shaping information generator includes information of a pattern in the three-dimensional shaping information, and
the shaping part shapes the three-dimensional object and then prints the pattern on the three-dimensional object.

9. The manufacturing apparatus according to claim 8,
wherein the pattern is at least one selected from information of decoration of the yarn, information of a raw material of the yarn and a twining state of the yarn, and information of decoration of a textile fabric formed by weaving the yarn.

10. The manufacturing apparatus according to claim 1,
wherein the three-dimensional shaping information generator includes information of an image in the three-dimensional shaping information, and
the manufacturing apparatus further comprises a printing part that prints an image on a surface of the three-dimensional object based on the three-dimensional shaping information including the information of the image.

11. The manufacturing apparatus according to claim 1,
wherein the yarn-related information receiver and the weaving method receiver respectively receive information of a plurality of combinations of the yarns and information of a weaving method for the plurality of combinations of the yarns,
the three-dimensional shaping information generator generates a plurality of pieces of three-dimensional shaping information of the three-dimensional object based on the information of the plurality of combinations of the yarns and the information of the weaving method for the plurality of combinations of the yarns and combines the plurality of pieces of three-dimensional shaping information to generate three-dimensional shaping information of a composite three-dimensional object, and
the shaping part shapes the composite three-dimensional object based on the three-dimensional shaping information of the composite three-dimensional object.

12. The manufacturing apparatus according to claim 11,
wherein the three-dimensional shaping information generator includes information of an image in the three-dimensional shaping information, and
the manufacturing apparatus further comprises a printing part that prints an image on a surface of the composite three-dimensional object based on the three-dimensional shaping information including the information of the image.

13. A manufacturing method for a three-dimensional object, comprising:
a yarn-related information receiving step of receiving information inputted of a yarn;
a weaving method receiving step of receiving information inputted of a weaving method for the yarn;
a three-dimensional shaping information generating step of generating three-dimensional shaping information of the three-dimensional object based on the information of the yarn and the information of the weaving method for the yarn; and
an object shaping step of shaping the three-dimensional object on a working plane by ejecting an object forming material onto the working plane and curing the object forming material ejected based on the three-dimensional shaping information.

14. A manufacturing apparatus for manufacturing a textile-like structural object that appears to be a textile fabric formed by interweaving a plurality of warp yarns and a plurality of weft yarns, the manufacturing apparatus comprising:
a shaping part that shapes the three-dimensional object on a working plane by ejecting an object forming material onto the working plane and curing the object forming material ejected, and
the shaping part forming a part with an overlap between structures of respective ones of the plurality of warp yarns and the plurality of weft yarns in a greater thickness in a view from a surface side than a part with no overlap between structures of the plurality of warp yarns and the plurality of weft yarns.

15. The manufacturing apparatus according to claim 14,
wherein the shaping part starts with shaping a structure of a lower-side yarn in the part with the overlap and then shapes a structure of an upper-side yarn in the part with the overlap.

16. The manufacturing apparatus according to claim 15,
wherein the shaping part shapes the structure of the upper-side yarn in the part with the overlap in a greater thickness than the structure of the upper-side yarn in any part but the part with the overlap.

17. The manufacturing apparatus according to claim 15,
wherein the shaping part shapes the structure of the upper-side yarn in the part with the overlap in a thickness of structures stacked in layers of the upper-side yarn and the lower-side yarn in the part with the overlap, instead of further shaping the structure of the lower-side yarn in the part with the overlap.

18. The manufacturing apparatus according to claim 15,
wherein the shaping part shapes the structure of the upper-side yarn in the part with the overlap so as to have a taper starting from the part with the overlap toward a part with no overlap between structures of respective ones of the plurality of warp yarns and the plurality of weft yarns.

19. The manufacturing apparatus according to claim 14,
wherein the shaping part uses an opaque ink to shape the three-dimensional object.

20. The manufacturing apparatus according to claim 19,
wherein the opaque ink comprises a white pigment, and
the white pigment includes any one selected from a hollow white pigment, micro-encapsulated titanium oxide, micro-encapsulated zinc oxide, and nanoparticles having an average particle size less than or equal to 300 nm.

21. A three-dimensional object, comprising:
a plurality of structures of first yarn formed by curing an object forming material and extending in a direction, and
a plurality of structures of second yarn formed by curing an object forming material and extending in another direction intersecting with the plurality of structures of first yarn, the plurality of structures of first yarn and the plurality of structures of the second yarns being interwoven.

22. The three-dimensional object according to claim 21,
wherein at least one of respective ones of the plurality of structures of first yarn and the plurality of structures of second yarn comprises an opaque ink.

23. The manufacturing apparatus according to claim 22,
wherein the opaque ink comprises a white pigment, and
the white pigment includes any one selected from a hollow white pigment, micro-encapsulated titanium oxide, micro-encapsulated zinc oxide, and nanoparticles having an average particle size less than or equal to 300 nm.
